(19) United States
(12) Patent Application Publication
(10) Pub. No.: US 2023/0242718 A1
(43) Pub. Date: Aug. 3, 2023

(54) FIBER PRETREATMENT FOR IMPROVED NATURAL FIBER - POLYMER COMPOSITE FEEDSTOCK PRODUCTION

(71) Applicant: University of Louisville Research Foundation, Inc., Louisville, KY (US)

(72) Inventors: Jagannadh Satyavolu, Louisville (US); Kunal Kate, Louisville (US); Vamsi Balla, Louisville (US); Jogi Ganesh Dattatreya Tadimeti, Louisville, KY (US); Chamila Rajeeva Thilakaratne, Louisville (US)

(73) Assignee: University of Louisville Research Foundation, Inc., Louisville, KY (US)

(21) Appl. No.: 18/013,010

(22) PCT Filed: Jul. 2, 2021
(86) PCT No.: PCT/US2021/040342

§ 371 Date: Dec. 27, 2022

Related U.S. Application Data
(60) Provisional application No. 63/047,454, filed on Jul. 2, 2020.

(51) Int. Cl. C08J 5/04; B29C 64/118; B33Y 70/10; B33Y 10/00

(52) U.S. Cl. CPC C08J 5/045; B29C 64/118; B33Y 70/10; B33Y 10/00; B29K 2311/10

(57) ABSTRACT

Provided are methods for preparing modified natural fiber composite feedstocks. In some embodiments, the presently disclosed methods include hydrolyzing agricultural fiber material, optionally soybean hulls, under conditions and for a time sufficient to remove some or all of the arabinose from the agricultural fiber material to produce an arabinose-deficient hydrolyzed product; hydrolyzing the arabinose-deficient hydrolyzed product under conditions and for a time sufficient to remove some or all of the xylose from the arabinose-deficient hydrolyzed product to produce a hydrolyzed fiber material; and combining a thermoplastic copolyester (TPC) with up to 35 wt. % by weight of the hydrolyzed material, whereby a modified fiber composite feed stock is prepared. Also provided are methods for isolating xylose removed from arabinose-deficient hydrolysates, modified fiber composites prepared by the presently disclosed methods, method for 3D printing structure using the modified fiber composites, methods for improving at least one characteristic of modified TPC composites, and methods for improving fused filament fabrication (FEE) processes.

### CROSS REFERENCE TO RELATED APPLICATION

This application claims the benefit of U.S. Provisional Patent Application Ser. No. 63/047,454, filed Jul. 2, 2020, the disclosure of which is incorporated herein by reference in its entirety.

### TECHNICAL FIELD

The presently disclosed subject matter generally relates to compositions and methods for preparing modified natural fiber composite feedstocks and using the same in applications including but not limited to injection molding and fused filament fabrication (FFF) processes.

### BACKGROUND

Natural fibers in polymer composites (natural fiber composites, NFCs) have gained significant attention due to environmental concerns (Faruk et al., 2012), cost-effectiveness, and performance. A wide variety of natural fibers (wood, kenaf, hemp, jute, flax, etc.) have been used to make thermosetting, thermoplastic and elastomer based composites using conventional processing techniques such as compression molding and injection molding (Mohammed et al., 2015; Balla et al., 2019). The market for NFCs is projected to have a compound annual growth rate (CAGR) of 11.8% during 2016-2024 (Grand View Research, 2018) due to the strong demand for sustainable manufacturing and energy efficiency. However, for their sustained growth in various industrial sectors, several challenges related to materials processing need to be addressed. For example, thermal stability of natural fibers above ˜200° C. is low and therefore processing temperatures and polymer matrices must be selected accordingly (Poletto et al., 2014).

Compared to conventional manufacturing processes, additive manufacturing (AM) of polymer composites provide several advantages including complex part geometries, functional gradation in properties and composition, custom designed and site-specific properties (Bandyopadhyay et al., 2011). Among different AM techniques fused filament fabrication (FFF) is most popular in fabricating polymer composites using variety of thermoplastics (Bourell et al., 2017). However, processing of NFCs using AM is very limited due to various processing challenges and difficulties associated with the properties of natural fibers, their blending in the polymer feedstock, and producing a composite with fewer inhomogeneities and with high stability/uniformity (Kalsoom et al., 2016; Balla et al., 2019). For example, a recent study on FFF of poly(lactic acid) (PLA)+poly(hydroxyalkanoate) (PHA) blend loaded with ˜15 wt. % wood fibers showed properties lower than conventionally processed PHA-20% wood composites (Le Duigou et al., 2016). It was observed that the feedstock composite filament had high amount of porosity (˜16.5%) which could not be eliminated using FFF. Increasing the parts size increased the severity of porosity and deteriorated the properties of composites (Le Duigou et al., 2016). Further, the high-temperature exposure during processing steps (compounding and extrusion) involved in preparing NFC filament for FFF can damage natural fibers. Additional degradation in the natural fibers can be expected during printing parts using FFF (Venkataraman, 2000). Other problems include increased viscosity and brittleness with increasing fiber concentration (Zhong et al., 2001), severe nozzle clogging (Kalsoom et al., 2016), void formation (Le Duigou et al., 2016), fiber agglomeration (Tanguy et al., 2018), feature resolution, fiber-matrix interfacial characteristics (George et al., 2001). Therefore, understanding the influence of fiber characteristics on rheological properties, fiber-matrix interactions, and properties of feedstock for FFF is very important as these play a decisive role in AM of NFCs and their properties (Balla et al., 2019).

Among different natural fibers, fibers derived from agriculture residues, soy hulls were very rarely studied as potential candidates for NFCs manufacturing (Ramesh et al., 2017; Bourmaud et al., 2018; Lau et al., 2018). Among different agricultural biomass available in the USA, soybean hulls generation during soybean processing is one of the highest with 123 million tons (4.54 billion bushels) of soybean processed in the year 2018 (United States Department of Agriculture, 2019). Currently the main products of soybean processing include oil and protein, and soybean derived protein-based materials and composites find wide variety of applications (Tian et al., 2018). However, during processing of soybean significant amount of soy hulls is generated which is currently used as soymeal and animal feed (Alemdar & Sam, 2008). Chemomechanical treatments have been used on soybean hulls to obtain micro- and nano fibers which exhibited good mechanical properties (Alemdar & Sam, 2008). Thermal degradation temperature of these fibers increased from 209° C. to 290° C. and about 10% improvement in the cellulose crystallinity was reported with chemical treatment (Alemdar & Sam, 2008). Cellulosic microfibrils and microparticles derived from the soybean hulls were found to exhibit ˜10% higher crystallinity which enhanced their thermal stability up to 295° C. compared to wood fibers (Ferrer et al., 2016). Interestingly, measurable shear thinning behavior was also observed in aqueous dispersion with up to 1 wt. % of soybean hull derived fibers (Ferrer et al., 2016), which enable easy processing of fiber dispersions. Hybrid films made using soybean hull fibers and wood fibers exhibited superior thermal barrier properties when wood fibers, up to 75%, were replaced with soybean hull fibers (Ferrer et al., 2015). These studies clearly show strong potential of soybean hull fibers as reinforcing materials in wide variety of polymers. Further, abundant availability and low-cost of soybean hulls also provide economical advantage and easy acceptance to soybean hull fiber reinforced polymer composites.

Therefore, as disclosed herein, thermoplastic copolyester (TPC) composite filaments reinforced with pretreated (e.g., chemically treated) soybean hull fibers (CTSHF) and untreated soybean hull fibers (UTSHF) were prepared, with 5 and 10 wt. % concentration, to understand the effects of fiber/hulls concentration on rheological, microstructural and mechanical properties of composite filaments for use in FFF. Detailed microstructural analysis was carried out to assess fiber distribution, microstructural uniformity, porosity formation, and fiber-matrix interfacial defects. These observations were correlated with tensile mechanical properties of TPC-CTSHF and TPC-UTSHF composite filaments.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this Summary does not list or suggest all possible combinations of such features.

In some embodiments, the presently disclosed subject matter relates to methods for preparing modified natural fiber composite feedstocks. In some embodiments, the methods comprise (a) hydrolyzing agricultural fiber material, optionally agricultural fiber material comprising one or more of grain hull fibers such as corn, soy, rice, which in some embodiments are soybean hulls, under conditions and for a time sufficient to remove some or all of the arabinose from the agricultural fiber material to produce an arabinose-deficient hydrolyzed product; (b) thereafter hydrolyzing the arabinose-deficient hydrolyzed product under conditions and for a time sufficient to remove some or all of the xylose from the arabinose-deficient hydrolyzed product to produce a hydrolyzed fiber material; and (c) combining a thermoplastic copolyester (TPC) with up to 35 wt. % by weight of the hydrolyzed fiber material, whereby a modified fiber composite feed stock is prepared.

In some embodiments, the agricultural fiber material comprises, consists essentially of, or consists of soybean hulls. In some embodiments, the agricultural fiber material comprises, consists essentially of, or consists of corn husks. In some embodiments, the agricultural fiber material comprises, consists essentially of, or consists of a combination of soybean hulls and corn husks.

In some embodiments, the first hydrolyzing step, the second hydrolyzing step, or both employ an acid.

In some embodiments, the first and second hydrolyzing steps are performed together or separately at the same temperature.

In some embodiments, the first hydrolyzing step employs a lower concentration of acid, a shorter treatment time, or both as compared to the concentration of acid and/or the treatment time employed in the second hydrolyzing step.

In some embodiments, the first hydrolyzing step removes at least about 40%, 50%, 60%, 70%, or greater than 70% of the arabinose present in the agricultural fiber material, and/or removes less than 25%, 20%, 15%, or 10% of the xylose present in the agricultural fiber material.

In some embodiments, the second hydrolyzing step removes at least about 40%, 50%, 60%, 70%, or greater than 70% of the arabinose remaining in the arabinose-deficient hydrolysis product, and/or removes greater than 70%, 75%, 80%, 85%, or 90% of the xylose remaining in the arabinose-deficient hydrolysis product.

In some embodiments, the thermoplastic copolyester (TPC) is combined with 5-35% by weight of the hydrolyzed agricultural fiber material (e.g., hydrolyzed soybean hull fiber material).

In some embodiments, the combining of the thermoplastic copolyester (TPC) with the hydrolyzed agricultural fiber material (e.g., hydrolyzed soybean hull fiber material) results in a decrease in viscosity of the modified fiber composite as compared to the viscosity of the TPC absent the hydrolyzed agricultural fiber material (e.g., the hydrolyzed soybean hull fiber material).

In some embodiments, the combining of the thermoplastic copolyester (TPC) with the hydrolyzed agricultural fiber material (e.g., hydrolyzed soybean hull fiber material) results in an increase in the elastic modulus of the modified fiber composite of at least about 10%-50% as compared to the elastic modulus of the TPC absent the hydrolyzed agricultural fiber material (e.g., hydrolyzed soybean hull fiber material).

In some embodiments, the combining of the thermoplastic copolyester (TPC) with the hydrolyzed agricultural fiber material (e.g., hydrolyzed soybean hull fiber material) results in an increase in the toughness of the modified fiber composite of at least about 10%-30% as compared to the toughness of the TPC absent the hydrolyzed agricultural fiber material (e.g., hydrolyzed soybean hull fiber material).

In some embodiments, the modified fiber composite exhibits less than 10% moisture uptake when immersed in distilled water for up to 7 days.

In some embodiments, the presently disclosed methods further comprise isolating the xylose removed from the arabinose-deficient hydrolysate.

In some embodiments, the isolating comprises (d) concentrating the xylose-containing solution produced in step (b) to greater than about 100 g/L; (e) combining a boron compound with the concentrated xylose-containing solution to produce a xylose diester (XDE) boron derivative of the xylose; (f) transesterifying the XDE boron derivative, optionally wherein the transesterifying is with propylene glycol, to form a precipitate, wherein the comprises xylose; and (g) optionally filtering and/or washing the xylose to remove any solvents and impurities, wherein the xylose is isolated from the arabinose-deficient hydrolysis product.

In some embodiments, the presently disclosed subject matter also relates to modified fiber composites comprising up to 35 wt. % hydrolyzed agricultural fiber material (e.g., hydrolyzed soybean hull fiber material, corn husk material, or combinations thereof).

In some embodiments, the modified fiber composites are produced by a method as disclosed herein.

In some embodiments, the presently disclosed subject matter also relates to methods for 3D printing structures. In some embodiments, the methods comprise preparing a modified fiber composite as disclosed herein and employing the modified fiber composite in a fused filament fabrication (FFF) based additive manufacturing method to thereby print the structure.

In some embodiments, the presently disclosed subject matter also relates to methods for improving at least one characteristic of a modified thermoplastic copolyester (TPC) composite. In some embodiments, the methods comprise (a) hydrolyzing agricultural fiber material (including but not limited to soybean hulls and/or corn husks) under conditions and for a time sufficient to remove some or all of the arabinose from the agricultural fiber material to produce an arabinose-deficient hydrolysis product; (b) thereafter hydrolyzing the arabinose-deficient hydrolyzed product under conditions and for a time sufficient to remove some or all of the xylose from the arabinose-deficient hydrolyzed product to produce a hydrolyzed agricultural fiber material (e.g., hydrolyzed soybean hull fiber material); and (c) combining a thermoplastic copolyester (TPC) with up to 35% by weight of the hydrolyzed agricultural fiber material (e.g., hydrolyzed soybean hull fiber material), wherein the at least one characteristic is selected from the group consisting of reduced viscosity, reduced interfacial void spaces, enhanced fiber dispersion, and higher relative density of the TPC composite relative to the TPC lacking the hydrolyzed soybean hull fiber.

In some embodiments, the presently disclosed subject matter also relates to methods for improving a fused filament fabrication (FFF) process. In some embodiments, the methods comprise employing a modified fiber composite as disclosed herein rather than a thermoplastic copolyester (TPC) lacking the up to 35 wt. % hydrolyzed agricultural fiber material (e.g., hydrolyzed soybean hull fiber material), wherein the improving comprises a reduction in a parameter of the FFF process selected from the group consisting of viscosity, brittleness, nozzle clogging, void formation, fiber agglomeration, increased feature resolution, and/or an improved fiber-matric interfacial bonding characteristic.

In some embodiments, the presently disclosed subject matter also relates to methods for reducing occurrence of void spaces in modified thermoplastic copolyester (TPC) composites. In some embodiments, the methods comprise (a) hydrolyzing agricultural fiber material, optionally soybean hull fiber material, under conditions and for a time sufficient to remove some or all of the arabinose from the agricultural fiber material to produce an arabinose-deficient hydrolysis product; (b) thereafter hydrolyzing the arabinose-deficient hydrolysis product under conditions and for a time sufficient to remove some or all of the xylose from the arabinose-deficient hydrolysis product to produce a hydrolyzed fiber material, optionally a hydrolyzed soybean hull fiber material; and (c) combining a thermoplastic copolyester (TPC) with up to 35% by weight of the hydrolyzed fiber material, optionally the hydrolyzed soybean hull fiber material, to produce a modified thermoplastic copolyester (TPC) composite. In some embodiments, the modified thermoplastic copolyester (TPC) composite has a reduced occurrence of void spaces relative to the same thermoplastic copolyester (TPC) combined with up to 35% by weight of the same fiber material that has not been hydrolyzed. In some embodiments, the modified thermoplastic copolyester (TPC) composite has an improvement of at least at least one additional characteristic selected from the group consisting of reduced viscosity, and higher relative density of the TPC composite relative to the TPC lacking the hydrolyzed fiber material. In some embodiments, the extent to which the modified thermoplastic copolyester (TPC) composite has a reduced occurrence of void spaces is at least about 40%, 50%, 60%, 70%, or greater than 70% relative to the same thermoplastic copolyester (TPC) combined with up to 35% by weight of the same fiber material that has not been hydrolyzed.

Thus, it is an object of the presently disclosed subject matter to provide compositions and methods for preparing modified natural fiber composite feedstocks and using the same in fused filament fabrication (FFF) processes.

An object of the presently disclosed subject matter having been stated hereinabove, and which is achieved in whole or in part by the presently disclosed subject matter, other objects will become evident as the description proceeds when taken in connection with the accompanying Figures as best described herein below.

### BRIEF DESCRIPTION OF THE FIGURES

FIGS. 1A-ID. Morphology of soy hulls after various different treatment conditions, including AR-Dry (FIG. 1A), AR-Shear (FIG. 1B), ST1 (FIG. 1C), and ST2 (FIG. 1D). See Table 1 for explanation of the conditions that correspond to these abbreviations.

FIGS. 2A-2D. Comparison of soy hulls derived fibers in AR-Dry (FIG. 2A), AR-Shear (FIG. 2B), ST1 (FIG. 2C), and ST2 (FIG. 2D). Arrows indicate defibrillated microfibrils.

FIG. 3. Influence of soy hull fibers and their concentration on the viscosity of TPC composites during filament extrusion (165° C., 30 s⁻¹). p<0.05 for TPC vs all composites (Student t-test).

FIGS. 4A-4D. Surface topography of pure TPC and TPC-soy fiber composite filaments under various conditions, including untreated (TPC; left panel of FIG. 4A), 5AR-DRY (right panel of FIG. 4A), 5AR-SHEAR (left panel of FIG. 4B), 10AR-SHEAR (right panel of FIG. 4B), 5ST1 (left panel of FIG. 4C), 10ST1 (right panel of FIG. 4C), 5ST2 (left panel of FIG. 4D), and 10ST2 (right panel of FIG. 4D). Insets show exposed soybean hull fibers. The black line at the bottom right of each panel corresponds to 500 μm, and the black line at the bottom right of each inset corresponds to 100 μm.

FIGS. 5A and 5B. FIG. 5A is a graph of the relative density of TPC composite filaments with varying concentration of different soy hull fibers. FIG. 5B is a graph of the effect of soybean hull fiber on the pore size of TPC-soybean hull fiber composite filaments. p<0.05 for relative density of TPC vs all composites, except vs. 5ST1 (Student t-test).

FIGS. 6A-6D. Longitudinal section microstructures showing the presence of porosity and distribution of soybean hull fibers in filaments prepared under different conditions, including untreated (TPC; left panel of FIG. 6A), 5AR-DRY (right panel of FIG. 6A), 5AR-SHEAR (left panel of FIG. 6B), 10AR-SHEAR (right panel of FIG. 6B), 5ST1 (left panel of FIG. 6C), 10ST1 (right panel of FIG. 6C), 5ST2 (left panel of FIG. 6D), and 10ST2 (right panel of FIG. 6D). The insets show the transverse section microstructures of the filaments. Arrows indicate pores and the broken circles indicate soybean hull fibers. The black lines at the bottom right of each panel and at the bottom right of each inset correspond to 500 μm.

FIGS. 7A-7E. Mechanical properties of pure TPC and TPC-soy fiber composite filaments, including elastic modulus (E; FIG. 7A); strength coefficient (K, Stress at True strain=1, which corresponds to 171% strain; FIG. 7B); true strain (ε) at 40 MPa true stress (FIG. 7C); strain hardening exponent (n; FIG. 7D); and toughness (area under true stress-strain curve; FIG. 7D). p<0.05 for E, K, ε, and ‘n’ of TPC vs CTSHF composites. p<0.005 for Toughness of TPC vs all composites, except vs 5ST1; (Student t-test).

FIGS. 8A-8F. Typical features observed on the filaments' surface and fracture surface after tensile testing for filaments prepared under different conditions, including untreated (TPC; FIG. 8A), 5AR-DRY (FIG. 8B), 10ST1 (FIG. 8C, right panel of FIG. 8D, and FIG. 8E), 5AR-DRY (left panel of FIG. 8D), and 10ST2 (FIG. 8F). The size bars are 100 μm (FIGS. 8A, right panel of FIG. 8B, right panel of FIG. 8C, and left panel of FIG. 8F), 50 μm (FIG. 8D and right panel of FIG. 8F), 10 μm (FIG. 8E), and 500 μm (left panel of FIG. 8B and left panel of FIG. 8C). Arrows indicate microfibrils and the broken circles indicate soybean hull fibers.

FIGS. 9A-9F. High-magnification microstructures showing fiber-matrix interfacial characteristics in different TPC-soy fiber composite filaments, including 10AR-DRY (FIG. 9A), 10AR-SHEAR (FIG. 9B), 10ST1 (FIG. 9C), 10ST2 and (FIG. 9D). FIGS. 9E and 9F are further magnified versions of 10ST1 and 10ST2, respectively. Arrows indicate fiber-matrix interfaces. The size bars are 20 μm in FIGS. 9A-9D or 10 μm in FIGS. 9E and 9F.

FIG. 10. The top panel is a photograph showing printing of soybean hull fiber reinforced TPC composites using a desktop printer. The bottom panel is a photograph of two exemplary coasters printed using the presently disclosed TPC-soybean hull fiber composites.

FIG. 11. SEM images showing the typical top surface (X-Y direction) topographical features of TPC and TPC-soybean hull fiber composites fabricated using FFF. Arrows indicate the interface between the beads and some defects at these regions. Circles in the in-set microstructures show complete bonding between adjacent beads.

FIG. 12. Typical build direction surface morphology of TPC and its composites. Arrows indicate interlayer interface/defects and exposed soybean hull fibers. In-sets show bonding between the layers at high magnification.

FIGS. 13A and 13B. Influence of soybean hull treatment and concentration on the surface roughness of 3D printed TPC composites (FIG. 13A) Top surface (X-Y direction), (FIG. 13B) Build direction (X-Z direction). The error bars represent variation in the roughness values. Of note is how the variation between 5 and 10% reduced after hydrolysis.

FIG. 14. Influence of soybean hull treatment and concentration on the relative density of 3D printed TPC composites. The error bars represent variation in the relative density values. Here as well, the variation between 5 and 10% reduced after hydrolysis.

FIG. 15. Typical light microstructures of 3D printed TPC and TPC-soybean hull fiber composites showing potential printing induced defects at geometrically difficult to fill areas (e.g., in part corners and transition regions between grip and gauge length in tensile test coupons).

FIG. 16. SEM microstructures showing distribution of porosity, soybean hull fibers, and printing defects in different 3D printed parts. Arrows indicate pores in the composites.

FIG. 17. Microstructures showing the influence of soybean hull fiber treatment on the porosity and fiber distribution in FFF fabricated TPC-soybean hull fiber composites. Pores/voids are marked with arrows and circles shows fibers or fiber bundles.

FIG. 18. High-magnification SEM microstructures of composites showing fibers/fiber bundles—matrix interfacial characteristics.

FIGS. 19A-19D. Comparison of tensile mechanical properties of pure TPC with TPC-soybean hull fiber composites showing the influence of fiber treatment (untreated (TPC), AR-Dry, AR-Shear, ST1, and ST2) and concentration. FIG. 19A is a graph of stress at 5% strain. FIG. 19B is a graph of stress at 50% strain, FIG. 19C is a graph of elastic modulus. FIG. 19D is a graph of toughness.*p<0.05 compared to pure TPC.

FIG. 20. Typical surface features (along the build direction) observed on the composite parts after tensile testing.

FIGS. 21A-21F. Comparisons of various characteristics among different agricultural fiber materials including wood, corn, and soy, treated with the methods of the presently disclosed subject matter, including viscosity (FIG. 21A), composite filament density (FIG. 21B), 3DP composite parts density (FIG. 21C), elastic modulus (FIG. 21D), strain hardening exponent (FIG. 21E), and toughness (FIG. 21F). The error bars represent variation in the relative values.

### DETAILED DESCRIPTION

The United States is world's largest producer of soybeans and significant amount of residual soybean hulls is generated during soybean processing. Soymeal and animal feed are the two current low-value outlets for the disposal of the hulls. In order to enhance the value of the soy hulls, disclosed herein is the use of soybean hull-derived fibers as a reinforcement in polymer matrix composite filaments for fused filament fabrication (FFF) based additive manufacturing. As disclosed herein, the soybean hulls were pre-treated with dilute acid hydrolysis followed by defibrillation of the hydrolyzed hulls. Both chemically treated soybean hull fibers (CTSHF) and untreated soybean hull fibers (UTSHF) with 5 and 10 wt. % concentrations were mixed within a thermoplastic copolyester (TPC) elastomer matrix to prepare composite filaments for FFF 3D printing. Studies were performed to understand the influence of CTSHF and UTSHF on the rheological, microstructural and mechanical properties of these composite filaments. The results indicated improved fiber defibrillation with high-shear mixing and dilute acid hydrolysis. Interestingly, the addition of 5 and 10 wt. % CTSHF to TPC matrix decreased the viscosity when compared to virgin TPC. Further, the CTSHF reduced the amount of porosity, enhanced fiber distribution and fiber-matrix interfacial adhesion in TPC-CTSHF composites, and resulted in enhanced mechanical properties compared to TPC-UTSHF composites.

### I. Definitions

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood there from. In case of conflict, the specification of this document, including definitions, will control.

While the terms used herein are believed to be well understood by those of ordinary skill in the art, certain definitions are set forth to facilitate explanation of the presently-disclosed subject matter.

Unless defined otherwise, all technical and scientific terms used herein have the same meaning as is commonly understood by one of skill in the art to which the invention(s) belong.

All patents, patent applications, published applications and publications, databases, websites and other published materials referred to throughout the entire disclosure herein, unless noted otherwise, are incorporated by reference in their entirety.

Where reference is made to a URL or other such identifier or address, it understood that such identifiers can change and particular information on the internet can come and go, but equivalent information can be found by searching the internet. Reference thereto evidences the availability and public dissemination of such information.

As used herein, the abbreviations for any protective groups, amino acids and other compounds, are, unless indicated otherwise, in accord with their common usage, recognized abbreviations, or the IUPAC-IUB Commission on Biochemical Nomenclature (see IUPAC-IUB Commission on Bio-Chemical Nomenclature Symbols for Amino-Acid Derivatives and Peptides. Recommendations (1971) (1972) Biochemistry 11(9):1726-1732).

Although any methods, devices, and materials similar or equivalent to those described herein can be used in the practice or testing of the presently-disclosed subject matter, representative methods, devices, and materials are described herein.

The present application can “comprise” (open ended), “consist of” (closed), or “consist essentially of” the components of the present invention as well as other ingredients or elements described herein. As used herein, “comprising” is open ended and means the elements recited, or their equivalent in structure or function, plus any other element or elements which are not recited. The terms “having” and “including” are also to be construed as open ended unless the context suggests otherwise.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±10%, in some embodiments ±0.50%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, “optional” or “optionally” means that the subsequently described event or circumstance does or does not occur and that the description includes instances where said event or circumstance occurs and instances where it does not. For example, an optionally variant portion means that the portion is variant or non-variant.

As used herein, the phrase “agricultural fiber material” refers to any agricultural biomass that can be employed as a starting material for the compositions and methods of the presently disclosed subject matter. Exemplary agricultural fiber materials include low cost agricultural fibers, such as crop residues (e.g., corn stover, rice straw, etc.) as well as process residues (e.g., grain hull fibers such as corn, soy, rice, etc.). It is understood that soybean hulls are employed as an exemplary agricultural fiber material of the presently disclosed subject matter, although other agricultural fiber materials including but not limited to corn husks can also be employed.

Various treatment methods are employed in the methods of the presently disclosed subject matter. These treatment methods are described herein and are summarized in Table 1. Additionally, the terms “5AR-SHEAR” and “10AR-SHEAR” refer to treatment with the AR-Shear procedure described in Table 1 of 5 wt. % modified soy fibers and 10 wt. % modified soy fibers, respectively. Similarly, the terms “5ST1” and “10ST1” refer to treatment with the ST1 procedure summarized in Table 1 of 5 wt. % modified soy fibers and 10 wt. % modified soy fibers, respectively, and the terms “5ST2” and “10ST2” refer to treatment with the ST2 procedure summarized in Table 1 of 5 wt. % modified soy fibers and 10 wt. % modified soy fibers, respectively.

### II. Embodiments

In some embodiments, the presently disclosed subject matter provides methods for preparing modified natural fiber composite feedstocks. In some embodiments, the methods comprise, consist essentially of, or consist of hydrolyzing soybean hulls under conditions and for a time sufficient to remove some or all of the arabinose from the soy hulls to produce an arabinose-deficient hydrolyzed product; thereafter hydrolyzing the arabinose-deficient hydrolyzed product under conditions and for a time sufficient to remove some or all of the xylose from the arabinose-deficient hydrolyzed product to produce a hydrolyzed soybean hull fiber material; and combining a thermoplastic copolyester (TPC) with up to 35 wt. % by weight of the hydrolyzed soy fiber material, whereby a modified fiber composite feed stock is prepared. In order to hydrolyze soybean hulls, in some embodiments the first hydrolyzing step, the second hydrolyzing step, or both employ an acid. Any acid can be employed in the first and/or second hydrolyzing step, including but not limited to sulfuric acid (H₂SO₄).

The hydrolyzing steps can take place under any set of reaction conditions (e.g., temperature and/or duration and/or acid concentration) provided that the reaction conditions are sufficient to provide a desirable extent of hydrolysis of the soy fiber material. Exemplary reaction conditions are disclosed herein, but it would be within the skill of one of ordinary skill in the art to modify the particular conditions disclosed herein to remove some or all of the xylose from the arabinose-deficient hydrolyzed product in order to produce a hydrolyzed soybean hull fiber material. Exemplary reaction conditions that can be employed together or separately include the first and second hydrolyzing steps being performed together or separately at the same temperature and/or employing a lower concentration of acid, a shorter treatment time, or both in the first hydrolyzing step as compared to the concentration of acid and/or the treatment time employed in the second hydrolyzing step.

One of the desirable outcomes of the first hydrolyzing step is to remove some or all of the arabinose naturally present in soybean hills. By way of example and not limitation, in some embodiments the first hydrolyzing step can be designed to remove at least about 40%, 50%, 60%, 70%, or greater than 70% of the arabinose present in the soybean hulls.

A second desirable outcome of the first hydrolyzing step is to retain as much of the xylose present in the soybean hulls as possible, optionally for removal in a separate, subsequent step. Thus, in some embodiments the first hydrolyzing step can remove less than 25%, 20%, 15%, 10%, or even 5% of the xylose present in the soybean hulls.

In some embodiments, the second hydrolyzing step is designed to remove some or all of the arabinose remaining in the soybean hulls as well as to remove some or all of the xylose present therein. Thus, in some embodiments the second hydrolyzing step is designed to remove at least about 40%, 50%, 60%, 70%, or greater than 70% of the arabinose remaining in the arabinose-deficient hydrolysis product created by the first hydrolyzing step, and/or removes greater than 70%, 75%, 80%, 85%, or 90% of the xylose remaining in the arabinose-deficient hydrolysis product created by the first hydrolyzing step. The xylose removed can then be recovered and/or otherwise isolated as set forth in more detail herein below.

In order to prepare the modified fiber composite, the hydrolyzed soy fiber material prepared as set forth herein is combined with a thermoplastic copolymer, which in some embodiments can be a thermoplastic copolyester. Methods and compositions that relate to thermoplastic copolymers include those set forth in U.S. Patent Application Publication Nos. 2017/0258623 and 2020/0180219, as well as U.S. Pat. Nos. 7,569,273; 10,173,410; 10,179,853; and 10,254,499, each of which is incorporated by reference in its entirety. Various relative amounts of the thermoplastic copolyester (TPC) and the hydrolyzed soybean hull fiber material can be employed, which by way of example and not limitation can include TPC combined with 5-35% by weight of the hydrolyzed soybean hull fiber material.

One of the goals of combining hydrolyzed soybean hull fiber material with TPC is to provide advantageous properties in the modified fiber composite as compared to the TPC lacking the hydrolyzed soybean hull fiber material. As disclosed herein, in some embodiments combining the TPC with the hydrolyzed soybean hull fiber material results in a decrease in viscosity of the modified fiber composite as compared to the viscosity of the TPC absent the hydrolyzed soybean hull fiber material.

Alternatively or in addition, combining the TPC with the hydrolyzed soybean hull fiber material can also result in an increase in the elastic modulus of the modified fiber composite. By way of example and not limitation, in some embodiments an increase of at least about 10%-50% increase in the elastic modulus of the modified fiber composite as compared to the elastic modulus of the TPC absent the hydrolyzed soybean hull fiber material can be achieved.

Also alternatively or in addition, combining the TPC with the hydrolyzed soybean hull fiber material can also result in an increase in the toughness of the modified fiber composite. By way of example and not limitation, in some embodiments an increase of at least about 10%-30% as compared to the toughness of the TPC absent the hydrolyzed soybean hull fiber material can be achieved.

The moisture content of the modified fiber can also be improved by combining TPC with the hydrolyzed soybean hull fiber material as disclosed herein. By way of example and not limitation, in some embodiments the modified fiber composite can exhibit less than 10% moisture uptake when immersed in distilled water for up to 7 days, which constitutes an improve as compared to typical moisture contents of TPC treated similarly.

As described herein, in some embodiments the presently disclosed methods for preparing modified fiber composites include one or more steps designed to remove arabinose and xylose from soybean hulls. In some embodiments, the xylose can be isolated from arabinose-deficient hydrolysate produced by the presently disclosed methods. By way of example and not limitation, in some embodiments the xylose removed from the arabinose-deficient hydrolysate is isolated by concentrating the xylose-containing solution produced via a method as disclosed herein to greater than about 100 g/L; combining a boron compound with the concentrated xylose-containing solution to produce a xylose diester (XDE) boron derivative of the xylose; transesterifying the XDE boron derivative, optionally wherein the transesterifying is with propylene glycol, to form a precipitate, wherein the comprises xylose; and optionally filtering and/or washing the xylose to remove any solvents and impurities, wherein the xylose is isolated from the arabinose-deficient hydrolysis product. This xylose isolation method is described in more detail in PCT International Patent Application Publication No. WO 2019/118476, which is incorporated herein by reference in its entirety. Also incorporated herein by reference in its entirety is PCT International Patent Application Publication No. WO 2019/118565.

In some embodiments, the presently disclosed subject matter also provides modified fiber composites as described herein. In some embodiments, the modified fiber composites comprise, consist essentially of, or consist of up to 35 wt. % hydrolyzed soy hulls, wherein the modified fiber composite is produced by a method as disclosed herein.

In some embodiments, the presently disclosed subject matter also provides methods for 3D printing structures employing the modified fiber composites described herein. In some embodiments, the presently disclosed methods comprise, consist essentially of, or consist of preparing a modified fiber composite as described herein and employing the modified fiber composite in a fused filament fabrication (FFF) based additive manufacturing method to thereby print the structure. Methods for 3D printing using FFF are known in the art, and include those described, for example, in U.S. Pat. Nos. 5,121,329; 5,510,066; 8,827,684; 10,232,443; 10,912,351; and 10,953,610; in U.S. Patent Application Publication Nos. 2015/0217514, 2016/0107379, 2018/0355196, and 2020/0269503, and in Compton, 2015 and Compton et al., 2014, each of which is incorporated by reference herein in its entirety.

Briefly, various types of 3D printing and printers for building products layer by layer (i.e., by additive manufacturing) have been described. One such example is stereolithography (SLA), which can be employed to produce high-resolution parts. However, parts produced using SLA typically are not durable, are also often not UV-stable, and thus are typically used for proof-of-concept work. To address some of the shortcomings of SLA, Fused Filament Fabrication (FFF) 3D printers can be used to build parts by depositing successive filament beads of acrylonitrile butadiene styrene (ABS) or a similar polymer.

Fused filament fabrication, also referred to as fused deposition modeling (FDM), typically employs a plastic filament or metal wire that is unwound from a coil and supplies material to an extrusion nozzle that can start and stop material flow. The nozzle is heated to melt the material and can be moved in both horizontal and vertical directions by a numerically controlled mechanism which is often directly controlled by a computer-aided manufacturing (CAM) software package. The model or part is produced by extruding small amounts of thermoplastic or other material (e.g., a thermoplastic copolyester; TPC) to form layers as the material hardens immediately after extrusion from the nozzle. Tools for thermoforming and injection molding can be made, as well as fixtures which assist the manufacturing operation. In addition to providing for very low run manufacturing operations, art objects and display objects can be readily manufactured. Improvements of fused filament fabrication printers requires an increase in printing speed, printing with multiple materials, and lower printer costs.

FFF systems and methods for using the same can include one or more of the following features. In some embodiments, a printer for FFF can comprise a reservoir to receive a build material from a source, the build material having a working temperature range between a solid and a liquid state, wherein the build material exhibits plastic properties suitable for extrusion, a heating system operable to heat the build material within the reservoir to a temperature within the working temperature range, a nozzle including an opening that provides a path for the build material, a drive system operable to mechanically engage the build material in solid form below the working temperature range and advance the build material from the source into the reservoir with sufficient force to extrude the build material, while at a temperature within the working temperature range, through the opening in the nozzle, and a former at the opening of the nozzle, the former configured to apply a normal force on the build material exiting the nozzle toward a previously deposited layer of the build material.

Additionally, in some embodiments the printer can comprise a forming wall with a ramped surface that inclines downward from the opening of the nozzle toward a surface of the previously deposited layer to create a downward force as the nozzle moves in a plane parallel to the previously deposited surface. In some embodiments, the printer can comprise a roller positioned to apply the normal force. In some embodiments, the printer can comprise a heated roller positioned to apply the normal force. In some embodiments, the printer can comprise a forming wall to shape the build material in a plane normal to a direction of travel of the nozzle as the build material exits the opening and joins the previously deposited layer. The forming wall can comprise a vertical feature positioned to shape a side of the build material as the build material exits the opening. In some embodiments, the printer can further comprise include a non-stick material disposed about the opening of the nozzle, the non-stick material having poor adhesion to the build material. The non-stick material may include at least one of a nitride, an oxide, a ceramic, and a graphite. The non-stick material may include a material with a reduced microscopic surface area. The build material can include a metallic build material, and where the non-stick material includes a material that is poorly wetted by the metallic build material. The build material can include a bulk metallic glass. The working temperature range can include a range of temperatures above a glass transition temperature for the bulk metallic glass and below a melting temperature for the bulk metallic glass. The build material can comprise a non-eutectic composition of eutectic systems that are not at a eutectic composition. The working temperature range can comprise a range of temperatures above a eutectic temperature for the non-eutectic composition and below a melting point for each component species of the non-eutectic composition. The build material can comprise a metallic base that melts at a first temperature and a high-temperature inert second phase in particle form that remains inert up to at least a second temperature greater than the first temperature. The working temperature range can comprise a range of temperatures above a melting point for the metallic base.

The build material can comprise a polymer, which in some embodiments can be a TPC or a modified TPC as disclosed herein. The printer can comprise a fused filament fabrication additive manufacturing system. The printer can further comprise a build plate and a robotic system, the robotic system configured to move the nozzle in a three-dimensional path relative to the build plate in order to fabricate an object from the build material on the build plate according to a computerized model of the object. The printer can comprise include a controller configured by computer executable code to control the heating system, the drive system, and the robotic system to fabricate the object on the build plate from the build material. The printer can further include a build chamber housing at least the build plate and the nozzle, the build chamber maintaining a build environment suitable for fabricating an object on the build plate from the build material. The printer can further include a vacuum pump coupled to the build chamber for creating a vacuum within the build environment. The printer can further include a heater for maintaining an elevated temperature within the build environment. The printer can further include an oxygen getter for extracting oxygen from the build environment. The build environment can in some embodiments be substantially filled with one or more inert gases. The one or more inert gases can be in some embodiments argon. The heating system can comprise an induction heating system. The printer can further comprise a cooling system configured to apply a cooling fluid to the build material as the build material exits the nozzle.

In some embodiments, the printer employs a thermoplastic. Exemplary thermoplastics that can be employed in 3D printing include, but are not limited to polylactic acid (PLA), acrylonitrile butadiene styrene (ABS), polycarbonate (PC), polyamides (e.g., nylons), polyvinyl alcohol (PVA), high-impact polystyrene (HIPS), high-density polyethylene (HDPE), and a thermoplastic copolyester (TPC). In some embodiments, the thermoplastic is a thermoplastic copolyester (TPC) composite, which in some embodiments can be a modified TPC composite.

In some embodiments, the presently disclosed subject matter also provides methods for improving at least one characteristic of a modified thermoplastic copolyester (TPC) composite. In some embodiments, the methods comprise, consist essentially of, or consist of (a) hydrolyzing soybean hulls under conditions and for a time sufficient to remove some or all of the arabinose from the soy hulls to produce an arabinose-deficient hydrolysis product; (b) thereafter hydrolyzing the arabinose-deficient hydrolysis product under conditions and for a time sufficient to remove some or all of the xylose from the arabinose-deficient hydrolysis product to produce a hydrolyzed soybean hull fiber material; and (c) combining a thermoplastic copolyester (TPC) with up to 35% by weight of the hydrolyzed soybean hull fiber material, wherein the at least one characteristic is selected from the group consisting of reduced viscosity, reduced interfacial void spaces, enhanced fiber dispersion, and higher relative density of the TPC composite relative to the TPC lacking the hydrolyzed soybean hull fiber.

In some embodiments, the presently disclosed subject matter also provides methods for improving a fused filament fabrication (FFF) process. In some embodiments, the methods comprise, consist essentially of, or consist of employing modified fiber composite as disclosed herein rather than a thermoplastic copolyester (TPC) lacking up to 35 wt. % hydrolyzed soy hulls, wherein the improving comprises, consists essentially of, or consists of a reduction in a parameter of the FFF process selected from the group consisting of viscosity, brittleness, nozzle clogging, void formation, fiber agglomeration, increased feature resolution, and/or an improved fiber-matric interfacial bonding characteristic.

In some embodiments, the presently disclosed subject matter also relates to methods for reducing occurrence of void spaces in modified thermoplastic copolyester (TPC) composites. In some embodiments, the methods comprise hydrolyzing agricultural fiber material, optionally soybean hull fiber material, under conditions and for a time sufficient to remove some or all of the arabinose from the agricultural fiber material to produce an arabinose-deficient hydrolysis product; thereafter hydrolyzing the arabinose-deficient hydrolysis product under conditions and for a time sufficient to remove some or all of the xylose from the arabinose-deficient hydrolysis product to produce a hydrolyzed fiber material, optionally a hydrolyzed soybean hull fiber material; and combining a thermoplastic copolyester (TPC) with up to 35% by weight of the hydrolyzed fiber material, optionally the hydrolyzed soybean hull fiber material, to produce a modified thermoplastic copolyester (TPC) composite. In some embodiments, the modified thermoplastic copolyester (TPC) composite has a reduced occurrence of void spaces relative to the same thermoplastic copolyester (TPC) combined with up to 35% by weight of the same fiber material that has not been hydrolyzed. In some embodiments, the modified thermoplastic copolyester (TPC) composite has an improvement of at least at least one additional characteristic selected from the group consisting of reduced viscosity, and higher relative density of the TPC composite relative to the TPC lacking the hydrolyzed fiber material. In some embodiments, the extent to which the modified thermoplastic copolyester (TPC) composite has a reduced occurrence of void spaces is at least about 20%, 30%, 40%, 50%, 60%, 70%, or greater than 70% relative to the same thermoplastic copolyester (TPC) combined with up to 35% by weight of the same fiber material that has not been hydrolyzed. In some embodiments, the extent to which the modified thermoplastic copolyester (TPC) composite has a reduced occurrence of void spaces is at least about 20%, 30%, 40%, 50%, 60%, 70%, or greater than 70% relative to the same thermoplastic copolyester (TPC) that lacks the up to 35% by weight of the same fiber material.

### EXAMPLES

The following EXAMPLES provide illustrative embodiments. In light of the present disclosure and the general level of skill in the art, those of skill will appreciate that the following EXAMPLES are intended to be exemplary only and that numerous changes, modifications, and alterations can be employed without departing from the scope of the presently disclosed subject matter.

### Materials and Methods for Examples 1-5

Soy hull treatment. Soybean hulls were obtained from Owensboro Grain Company (Owensboro, Ky.). These soybean hulls were used, with and without chemical treatment, to make TPC composite filaments. Initially, composite filaments with 5 and 10 wt. % of soy hulls were prepared to understand the influence of chemical treatment and concentration on their processing and properties. The soybean hulls without chemical treatment (UTSHF) were prepared by crushing them, in dry condition, using a household blender to reduce their size and enable uniform mixing (in some embodiments referred to herein as “TPC”. Similarly, another set of soybean hulls were crushed to finer size using high shear mixing in wet condition (soy hulls:water=1:1.75 wt. %; in some embodiments referred to herein as “AR-SHEAR”). For better wettability of soybean hull-derived fibers with TPC matrix, the hulls were chemically treated using dilute acid hydrolysis (CTSHF) in single (in some embodiments referred to herein as “ST1”) or two stage (in some embodiments referred to herein as “ST2”) processes (Fonseca et al., 2014; see also Tadimeti et al., 2020). The hydrolysis was performed in a 6 L percolation reactor (Fonseca et al., 2014) with liquid recirculation (M/K systems Inc, Peabody, Mass.). For each hydrolysis run, about 300 g of dry soy hulls was used and the hydrolysis temperature was 140° C. with an initial ramp time of 50 minutes (enable liquor to reach to hydrolysis temperature). Single-stage hydrolysis was performed for 1 hour (at 140° C.) using a dilute H₂SO₄ solution (4% acid w.r.t soy hulls) and 10 times the mass of the soy hulls. The two-stage process involved a first step that was similar to the single-stage procedure but with modifications as described in Tadimeti et al., 2020. Briefly, the second stage included 40 minutes hydrolysis at 140° C. followed by another acid hydrolysis of residual soybean hulls at 140° C. for 1 hour using dilute H₂SO₄ having 6% acid (w.r.t soy hulls) and lower liquor loading of seven times the mass of the soy hulls. After hydrolysis treatment, the soy hulls were separated from the liquor, washed thoroughly using water, and air-dried in ambient conditions. Then, the treated hulls were wet shear mixed (soy hulls:water=1:1.75 wt. %) to make a fine powder suitable for TPC composite filament production. The density of the treated and untreated soybean hulls was measured using gas pycnometer, which worked by measuring the pressure change due to displacement of helium gas by a solid object placed in a chamber. To determine the density of hulls, a small amount of hulls (˜1 g) was placed in a measuring container which is then sealed in a measuring chamber (of known volume) of the gas pycnometer. Then, the chamber was filled with helium gas followed by expansion of the gas into another reference chamber of known volume. The pressure changes in both chambers recorded during this process enabled accurate computation of the sample volume. The density of the samples was then calculated using measured mass and volume of the samples. Materials identification along with their treatment conditions are shown in Table 1.

TABLE 1
Treatment Conditions, Soybean Hull/Fiber Density
(g/cm³), Composite Filament Surface Roughness (μm)

| | | | Filament roughness, Ra | |
|---|---|---|---|---|
| Material | Treatment | Density | 5 wt. % | 10 wt. % |
| AR-Dry | As-received + | 1.456 ± 0.005 | 2.36 ± 0.5 | 5.65 ± 1.5 |
| | dry blend | | | |
| AR-Shear | As-received + | 1.506 ± 0.003 | 4.13 ± 1.4 | 5.87 ± 0.8 |
| | wet shear mixed | | | |
| ST1 | Single-stage | 1.494 ± 0.001 | 3.85 ± 0.8 | 4.74 ± 1.0 |
| | hydrolyzed | | | |
| ST2 | Two-stage | 1.495 ± 0.001 | 4.93 ± 1.6 | 6.09 ± 1.3 |
| | hydrolyzed | | | |
| TPC | As-received | 1.160 ± 0.005 | 0.19 ± 0.05 | |

TPC-soybean hull fiber composite filament preparation. Measured quantities of soybean hull fibers and TPC granules were loaded in a torque rheometer (Intelli-Torque Plasti-Corder, C. W. Brabender Instruments, Inc. South Hackensack, N.J.) and mixed at 180° C., 50 RPM. During mixing the torque was monitored and the mixing was continued until steady-state torque is reached, which indicates homogeneous mixing of TPC and soy hull fibers. For all composite mixtures prepared, steady-state torque was reached between 18 to 20 minutes. These composite mixtures were crushed into small granules (1 to 5 mm) and were extruded using capillary rheometer (Rheograph 20, GÖTTFERT Werkstoff-Prufmaschinen GmbH, Buchen, Germany) to fabricate composite filaments. Filament extrusion was carried out at 165° C. (all three zone of the extruder) with 0.15 mm/s speed (shear rate=30 s⁻¹) using Ø 1.75 mm tungsten carbide die. During extrusion, the torque was recorded and for each TPC-soy hull fiber composition and at least 48 measurements were made. The extruded filaments were assessed for their relative density using Archimedes' principle and average of ten measurements was reported.

Microstructural and mechanical characterization of filaments. The composite filaments were analyzed for their surface topography using scanning electron microscope (SEM, TESCAN USA, Inc., Warrendale, Pa.) to identify exposed soybean hull fibers. The surface roughness of the filaments was measured using a portable surface roughness tester (Surftest SJ-210, Mitutoyo America Corporation, Mason, Ohio). At least twelve scans were made on each filament using a scan length of 5 mm at 0.5 mm/s speed. The microstructure of the composite filaments was examined in transverse and longitudinal directions to assess fiber distribution, fiber-matrix interfacial characteristics, and porosity. For this purpose, the samples were mounted in acrylic polymer and then ground using a series of SiC emery papers followed by velvet cloth polishing with a 1 μm Al₂O₃ suspension.

Tensile testing of TPC-soybean hull fiber composite filaments, along with pure TPC, was carried out using universal testing machine at 100 mm/s crosshead speed. The gauge length of the test samples was 25 mm (total length=65 mm) and for each composition three samples were tested. From the force vs distance data recorded during tensile testing, mechanical properties of the filaments in terms of Young's modulus, strength coefficient, strain hardening exponent, toughness, and strain at 40 MPa stress were derived. After tensile testing, selected samples' surfaces and fracture surfaces were analyzed using SEM to understand the failure mechanism of these filaments.

Statistical analysis. The data related to fiber density, viscosity, porosity, relative density, roughness, and mechanical properties of composite fibers were analyzed using Student's t-test and p<0.05 was considered statistically significant.

### Example 1

### Soybean Hull Fibers and Their Influence on Viscosity

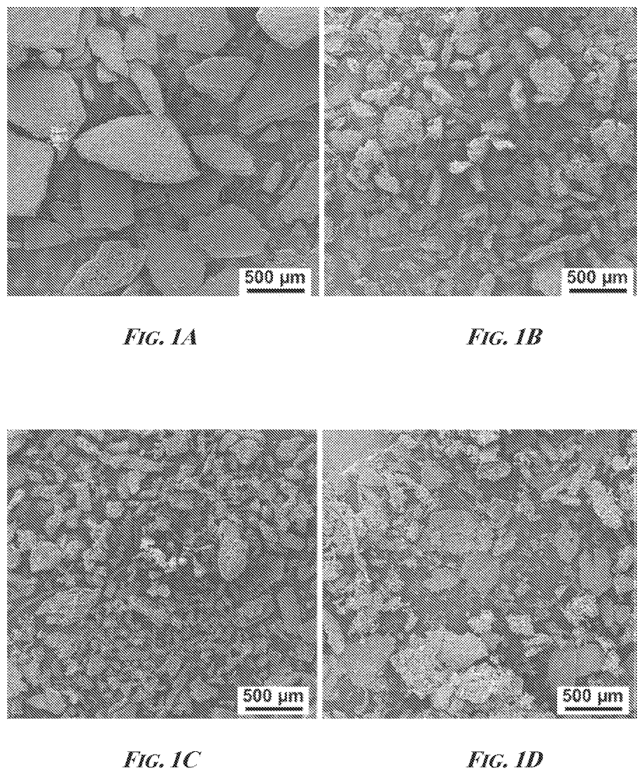

The soybean hull fibers, with and without chemical treatments, were initially examined used SEM to understand their morphologies and other characteristics. Low-magnification microstructures of the fibers produced are presented in FIGS. 1A-1D. AR-Dry samples, shown in FIG. 1A, exhibited flaky structure with coarse size, which was disintegrated to smaller size, irregular shape with high porosity after wet shear mixing (AR-Shear, FIG. 1B). Soybean hulls appeared to become more porous and finer in size after acid hydrolysis as shown in FIGS. 1C and 1D. This was primarily attributed to the removal of waxes, hemicellulose, pectin, and other impurities from the hulls during hydrolysis.

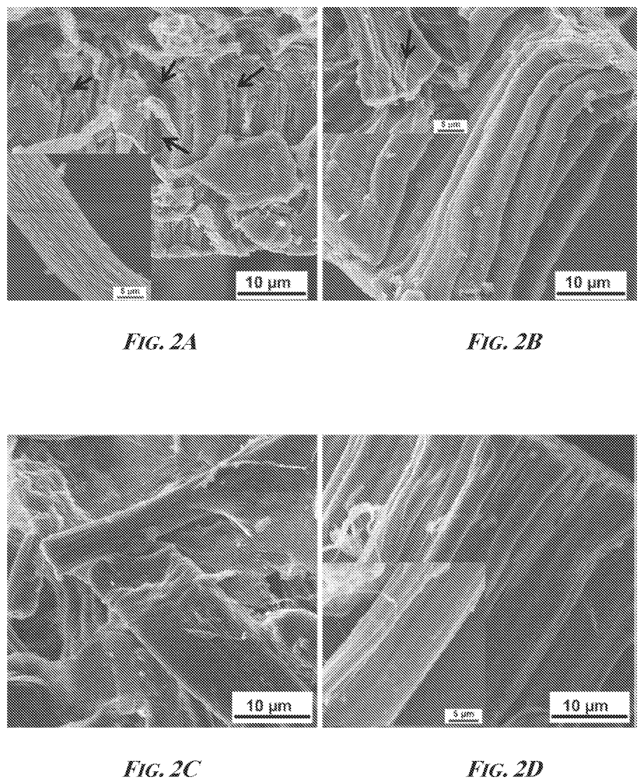

High-magnification analysis of the hulls revealed several fiber bundles in AR-Dry samples and isolated regions with defibrillation of bundles leading to formation of cellulosic microfibrils (marked with arrows in FIG. 2A). Further, some of the loosely bound fiber bundles were completely defibrillated and individual fibers with rough surface topography were formed, as shown in the inset of FIG. 2A. High-shear wet mixing appeared to remove significant amount of surface bound materials from the soybean hulls and fiber bundles (FIG. 2B). The surface of the fiber bundles was relatively smooth after wet shear mixing compared to those observed in AR-Dry condition (FIG. 2A). Furthermore, the shear forces during high-shear mixing appeared to mechanically shear the fibers thus exposing some of the cellulosic microfibrils (shown in inset of FIG. 2B; arrows). However, both physical treatments (dry crushing and high-shear wet mixing) resulted in fibers with ˜Ø 8 to 10 μm and length of 80 to 120 μm. After acid hydrolysis the fibers became smoother as shown in FIGS. 2C and 2D. No significant change in the morphology of soybean hull fibers was observed between single-stage and double-stage acid hydrolysis.

The viscosity of TPC-CTSHF and TPC-UTSHF composites is important to understand the processability of these composites using conventional and AM technologies. Average viscosity of different TPC-CTSHF and TPC-UTSHF composites measured during extrusion of filaments is presented in FIG. 3. The results showed considerable decrease in the viscosity of TPC with addition of CTSHF and UTSHF (p<0.05; Student t-test). The viscosity decreased from 2700 Pa·s to a range between 1775 and 2100 Pa·s with addition of 5 wt. % CTSHF and UTSHF in different treated conditions. However, with increase in the concentration of the fiber/hulls, the viscosity of UTSHF composites (AR-Dry and AR-Shear) increased, while the viscosity of CTSHF did not change (p>0.05).

These observations indicated the existence of shear thinning of TPC, to some extent, in the presence of soybean hull fibers, which was relatively high at low concentration of CTSHF. At low concentration of UTSHF, the AR-Dry samples showed lowest viscosity due to shear-induced breaking of coarse and flaky hulls (FIG. 1A) in these composites. The other three samples (AR-Shear, ST1, and ST2) showed almost similar viscosity, slightly higher than AR-Dry samples, which could be attributed to their finer size and absence of large amount of loose fiber bundles (shown in FIGS. 1B and 1C). Interestingly, CTSHF did not show any increase in the viscosity with increase in their concentration from 5 to 10 wt. %. Typically, increased addition of natural fibers to polymer matrices increases the viscosity due to mechanical restraints of fibers that obstruct the melt flow during extrusion. A similar trend has been reported in the wood fiber composites at low shear rates of 126 s⁻¹ (Maiti et al., 2004). At high shear rates (1995 s⁻¹) the melt flow can easily overcome mechanical restraints imposed by these natural fibers (Maiti et al., 2004). A similar effect of increased viscosity with increasing wood particles in polystyrene-wood composites has been reported (Kaseem et al., 2017). However, as disclosed herein, at 5 wt. % of CTSHF the viscosity of TPC decreased between 22 and 34%, while at 10 wt. % the decrease was between 7 and 36%. The observed decrease in the composite viscosity in the presence of soybean hull fibers could be due to (i) easy alignment of soybean hull fibers along the melt flow direction; (ii) smooth surface topography of fibers/fiber bundles in CTSHF, which provide least surface resistance against melt flow; (iii) low aspect ratio (10 to 15) and wall-slip effect (Hristov et al., 2006); (iv) presence of fiber bundles, agglomerates, which break during shear instead of obstructing the melt flow; and/or (v) changes in crystallinity (Bouafif et al., 2009) and molecular structure of matrix (Kaseem et al., 2017) due to interaction with soybean hull fibers.

### Example 2

### Surface Topography and Roughness of Composite Filaments

The density of the soybean hulls, in different conditions, measured using a gas pycnometer is presented in Table 1. Chemical treatment was found to increase the density of the fibers marginally and the density of as-received soybean hull was 1.46 g/cm³, which increased in the range of 1.49 to 1.51 g/cm³ after treatment. However, the statistical analysis (Student t-test) revealed that the increase in the fiber density due to chemical treatments was statistically significant (p<0.05) and no difference was found between ST1 and ST2 treatments.

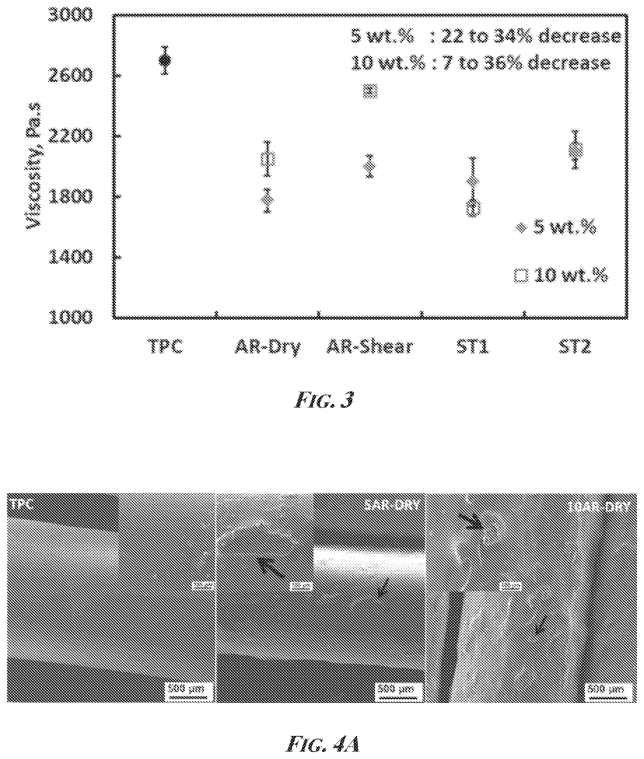

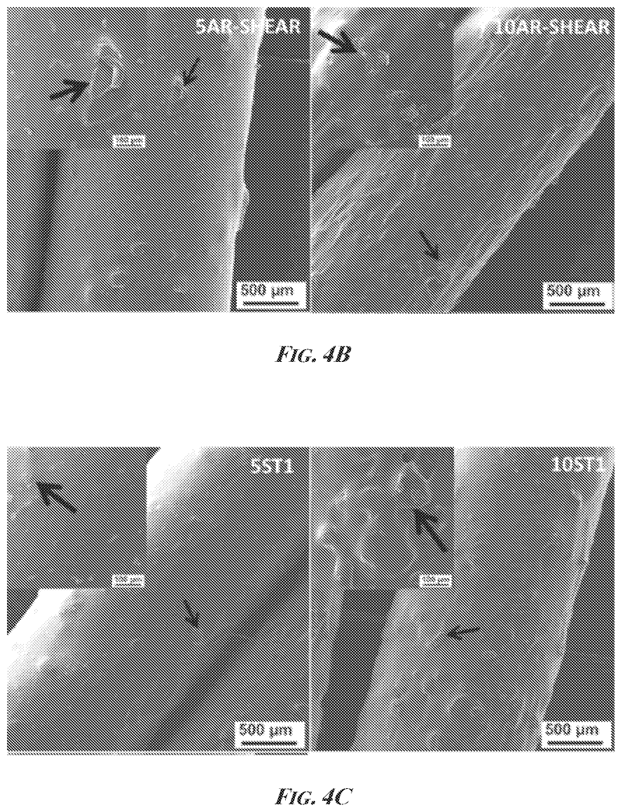

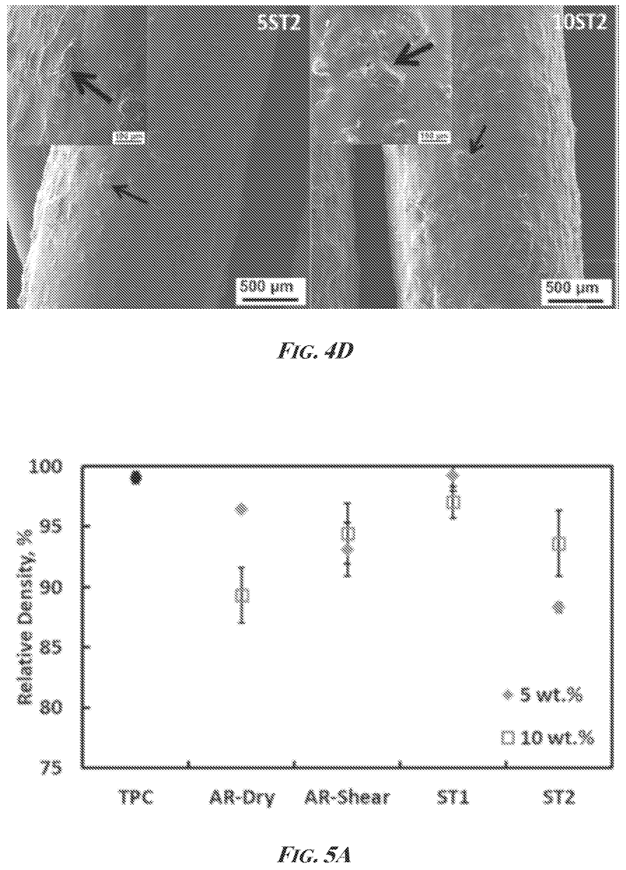

The surface morphology of the TPC-soybean hull fiber composite filaments was examined using SEM to understand the influence of soybean hulls on the morphology and also to assess the severity of exposed hull fibers. As shown in FIGS. 4A-4D, neat TPC filaments showed smooth surface morphology (FIG. 4A) as compared to composite filaments produced by the various methods disclosed herein (FIGS. 4B, 4C, and 4D). The composite filaments exhibited rough surface morphology with some hulls exposed to the filament surface. The average surface roughness (Ra) of these filaments is summarized in Table 1. The data indicated that pure TPC filaments had roughness of 0.19±0.05 m, which was increased after soybean hull fiber addition (2.36 and 6.09 μm). The insets in FIGS. 4A-4D show high-magnification SEM images of typical exposed soybean hull fibers on different composite filaments. Irrespective of treatments, all composite filaments exhibited an increase in the surface roughness (p<0.05; Student t-test) and number of exposed hulls/fibers with increase in the concentration of soybean hull fibers from 5 wt. % to 10 wt. %.

Furthermore, the roughness and fiber exposure in these composite filaments appeared to be directly related to the soybean hull fiber morphology/size (FIG. 1), depending on their treatment. For example, the coarse size of AR-Dry hulls resulted in isolated rough morphology on the extruded filaments compared to chemically treated soybean hull fibers (ST1 and ST2), which were finer in size and more uniformly distributed within the TPC matrix. Among different composite filaments described herein, ST1 filaments were found to have relatively more uniform surface roughness than other filaments. At 10 wt. %, these filaments exhibited a lower surface roughness of 4.74±1.0 μm compared to other composite filaments, which had a roughness in the range of 5.65-6.09 μm. The rough surface morphology and the presence of exposed soybean hull fibers on the surface of these composite filaments could have a strong influence on their deformation behaviors, failure mechanisms, and hence the mechanical properties. For example, these exposed soybean hull fibers could act as defects/stress raisers during tensile testing leading to premature crack initiation and deterioration of mechanical properties. Further, these exposed soybean hull fibers could easily absorb moisture during service and therefore might be detrimental to the moisture resistance of these NFCs.

### Example 3

### Density, Pore Size, and Soybean Hull Fiber Distribution in Composite Filaments

The relative densities of various TPC-soybean hull fiber composite filaments was compared with that of the pure TPC filament, and the results are shown in FIG. 5A. It can be seen that pure TPC had the highest relative density (99±0.5%) and among the composite filaments, ST1 filaments exhibited relative densities close to that of pure TPC. Other composite filaments were found to have densities in the range of 88-94% depending on the concentration of soybean hull fiber and treatment type. The composite filaments prepared using AR-Dry soybean hull fibers showed a significant decrease (p<0.05; Student t-test) in their density (96 to 89%) with increasing soybean hull fiber concentration (5 to 10 wt. %). However, high-shear mixing and chemical treatment of the soybean hulls appeared to reduce or eliminate this detrimental effect of increased soybean hull fiber concentration on the filament density.

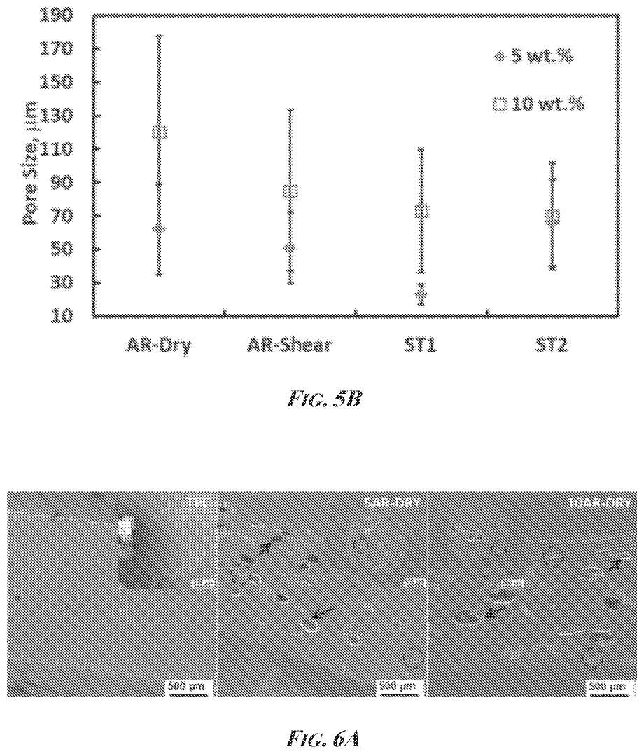

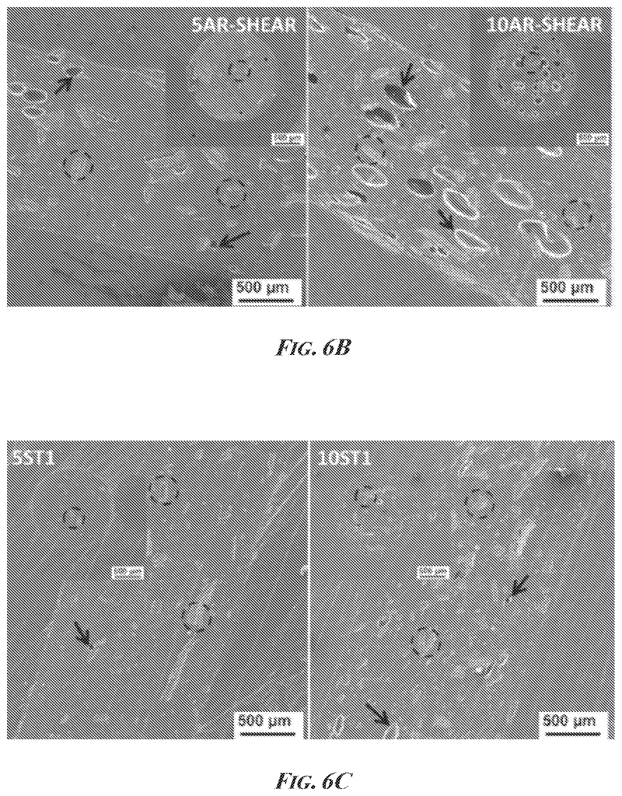

The microstructures of the extruded filaments were analyzed in transverse and longitudinal directions to understand the pore size, shape, and hull/fiber distributions. A comparison of typical microstructures of TPC-soybean hull fibers composites, in different directions, is presented in FIGS. 6A-6D. It can be seen from these microstructures that the addition of soybean hull fibers resulted in pore formation (arrows in FIGS. 6A-6D) during filament extrusion. The formation of porosity in these composite filaments was attributed to the presence of moisture in the soybean hull fibers, which upon evaporation during extrusion at 165° C. resulted in the gas pores. The majority of these pores were spherical in shape when examined in transverse section of the filaments (shown in the insets of FIGS. 6A-6D). However, these spherical pores appeared to be elongated, forming an elliptical shape, in the longitudinal sections of the filaments. This change in the pore shape was due to the deformation of the pores along the extrusion direction under the influence of extrusion pressure.

The presence of porosity has also been observed in PLA+PHA+15 wt. % wood fiber composite filaments used for FFF (Le Duigou et al., 2016). However, the amount of porosity in the PLA+PHA+15 wt. % wood fiber composite filaments was relatively higher (˜16.5%) than that of those described herein (≤11%) and could be correlated to low moisture absorption of soybean hull fibers compared to wood fibers. The sizes of the pores in different TPC-soybean hull fiber composite filaments was measured using multiple SEM images (see FIGS. 6A-6D) and the data is presented in FIG. 5B. The size of the pores varied from 23-120 μm depending on the concentration and type of soybean hull fiber. Moreover, a large scatter in the pore size was observed and the pore size increased with the concentration of soybean hull fiber (p<0.05; Student t-test). Increasing the concentration of soybean hull fiber resulted in further increase in the pore size scatter. The AR-Dry composite filaments, with 10 wt. % soybean hull fiber, exhibited the largest pore size of 120±58 m. Among different composite filaments, ST1 samples showed the smallest pore size at 5 wt. %, and both chemical treatments (ST1 and ST2) were found to provide comparable pore sizes at 10 wt. %. Overall, the chemical treatment of soybean hulls significantly reduced the pore size (p<0.05; Student t-test) and therefore were expected to provide better mechanical properties.

Another important observation made from these microstructures was the uniform distribution of soybean hull fibers (marked with broken circles in FIGS. 6A-6D), which indicated homogeneous mixing of fibers and TPC matrix during blending. The microstructures of the filaments in the longitudinal direction revealed alignment of longer soybean hull fibers along the filament axis (i.e., along the material flow/extrusion direction). The composite filaments made by chemically treated and high-shear mixed fibers showed random orientation of fine fibers. The presence of coarse soy fiber bundles in the present TPC composite filaments suggested that the pressure experienced by these bundles during compounding and extrusion was not sufficient to break them. This could also be due to strong bonding between the fibers, especially in AR-Dry samples. These fiber bundles could act as weak regions and could be detrimental to the mechanical properties of these composite filaments. Since the pressure involved in FFF of these composites was relatively lower than experienced during filament preparation, the final printed parts were also expected to have these fiber bundles. Therefore, for more efficient and uniform distribution of defibrillated soy fibers the feedstock should be free of fiber bundles.

### Example 4

### Mechanical Properties and Fracture of TPC-Soy Hull Fiber Composite Filaments

During tensile testing none of the filaments broke within the daylight limit of the tensile testing machine employed herein. Therefore, to assess the influence of soybean hull fiber reinforcement on TPC properties, the following relation was employed:

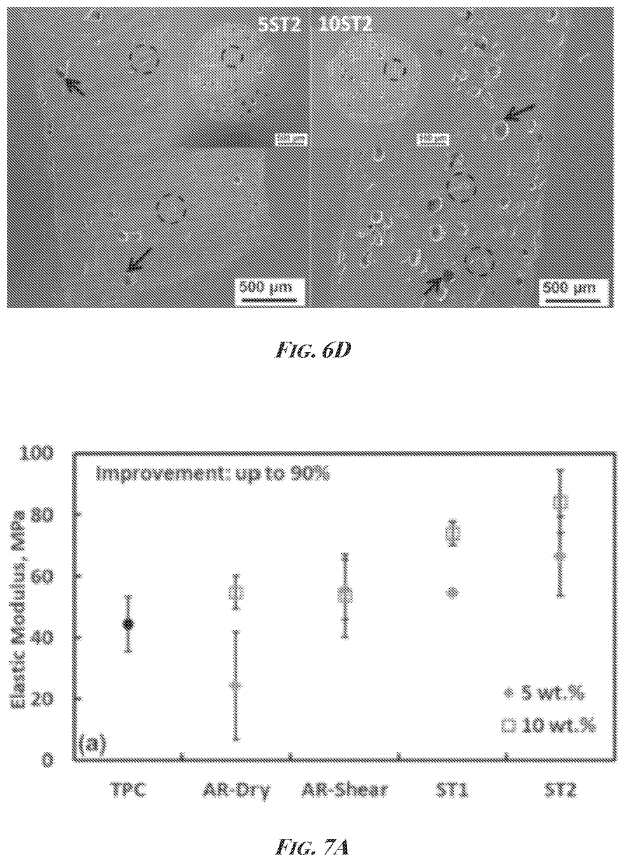

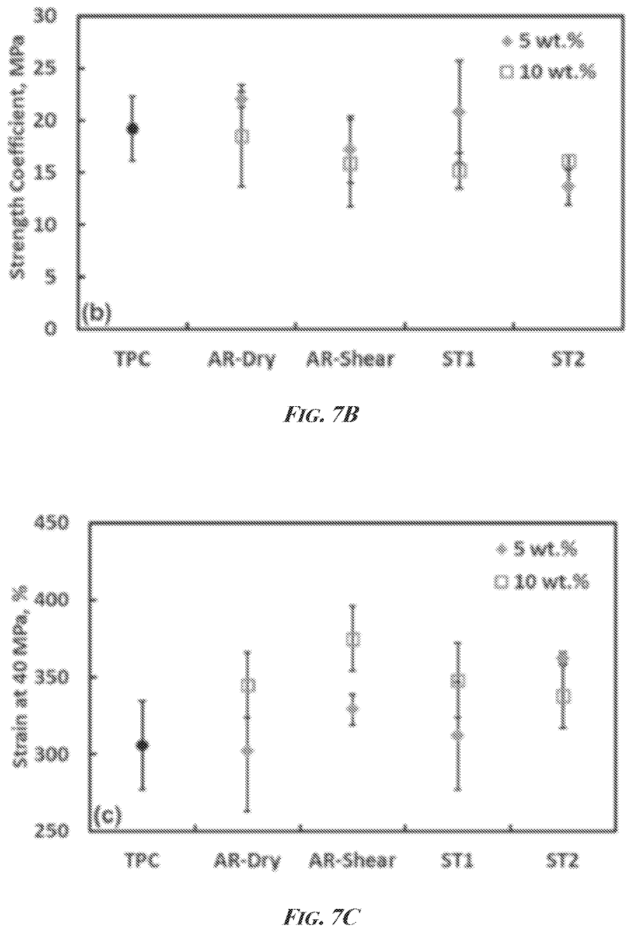

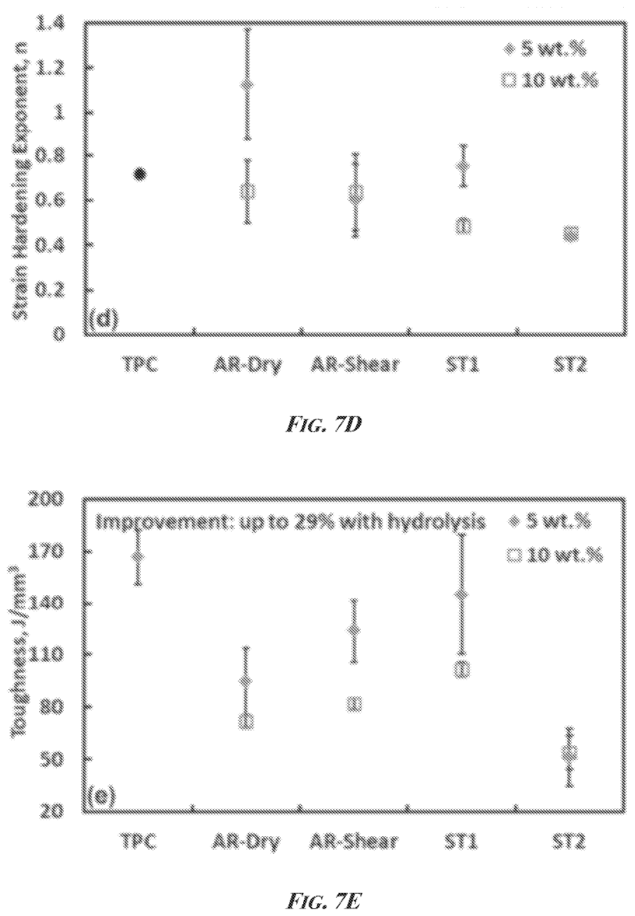

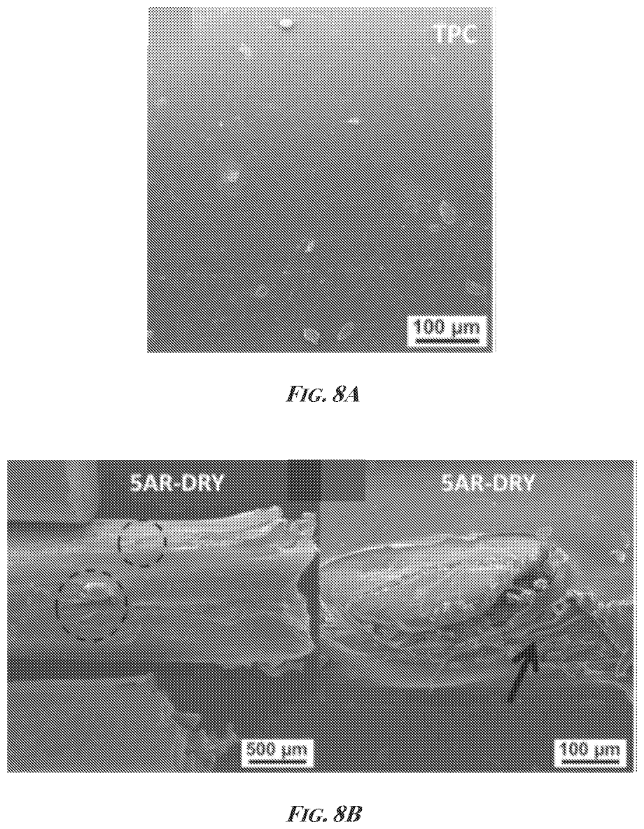

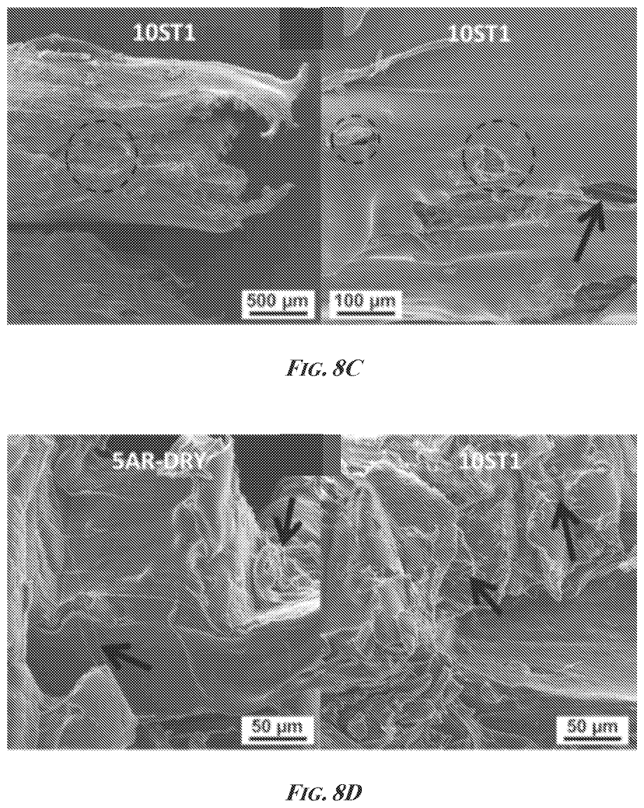

σ=K×εⁿ (1)

where σ is true stress, ε is true strain, K is the strength coefficient (is the true stress at unit true strain) and n is the strain hardening exponent (slope of log-log plot). It is considered that when n=0 the solid is perfectly malleable and when n=1 the solid becomes perfectly elastic. Tensile mechanical properties of composite filaments reinforced with soybean hull fibers thus determined are shown in FIG. 7.

The elastic modulus of pure TPC filament was found to be 44±8 MPa. After addition of 5 wt. % soybean hull fiber (ST2) the modulus of TPC increased to 66±12 MPa (see FIG. 7A). A further increase in the modulus up to 84±10 MPa was observed with increase in the ST2 soybean hull fiber concentration to 10 wt. %. The composite filaments with AR-Dry soybean hulls exhibited the lowest elastic modulus and was lower than pure TPC. However, high-shear mixing and chemical treatment of the soybean hulls was found to improve the elastic modulus of TPC-soybean hull fiber composite filaments (FIG. 7A; p<0.05; Student t-test). Relatively coarse size of AR-Dry hulls compared to AR-Shear hulls resulted in poor mechanical properties. Moreover, its poor fiber-matrix interfacial characteristics or bonding as a result of high hydrophilicity (due to lack of chemical treatment) would have contributed to its inferior mechanical properties compared to pure TPC. These results indicated that high elastic modulus can be achieved with ST2 composite filaments (TPC reinforced with two-stage hydrolyzed soybean hull fibers). Soybean hull concentration was also found to increase the modulus of these composite filaments.

The addition of UTSHF to TPC was found to have no significant influence on its strength coefficient (p>0.05; Student t-test). Interestingly, the strength coefficient of filaments marginally improved with addition of 5 wt. % soybean hull fibers compared to 10 wt. % filaments (see FIG. 7B), which was attributed to their large pore size and high amount of porosity. A small increase in the strength coefficient of the composite filaments indicated their superior resistance to deformation compared to that of pure TPC filaments. The chemical treatment of the soybean hull fiber also appeared to have negligible effect on the strength coefficient of these composite filaments compared to untreated fiber composite filaments (p>0.05). Increasing the concentration of soybean hull was found to decrease the strength coefficient, although not to a statistically significant degree (p>0.05; Student t-test), of these composite filaments. A small improvement in the strength of present TPC-soybean hull fiber composites could have been due to a low aspect ratio (10 to 12) of soybean hull fibers, which did not alter significantly due to different chemical treatments. These findings were corroborated with observed increase in the % strain of the CTSHF composite filaments (p<0.05; Student t-test; see FIG. 7C). However, the strain experienced by the UTSHF composite filaments was very close to that of pure TPC, suggesting that UTSHF had no detrimental effect on the elongation of TPC.

The strain at constant stress (40 MPa) increased (from 300% to 362%) with high-shear mixing and chemical treatment of soybean hulls when their concentration was 5 wt. % in TPC composites. At this concentration, a simultaneous increase in the stress and strain of TPC-soybean hull fiber composites clearly demonstrated their enhanced resilience. Further improvement in the strain was exhibited by the composites with 10 wt. % soybean hull fibers (345% to 375%), except this was not the case with ST2 composites.

The strain hardening exponent (n) provides good information on general elasticity or elastic behavior of present composites. It can be seen from FIG. 7D that the value of n for the composites with 10 wt. % soybean hulls (0.452 to 0.639) was lower than for pure TPC (0.715), which indicated some loss of elasticity of TPC due to the addition of soybean hull fibers (p<0.05; Student t-test). The decrease in the elastic behavior of TPC-soybean hull fiber composites could be attributed to the stiffening effect of soybean hull fibers, as shown in FIG. 7A. However, at 5 wt. % the loss of elasticity was small as this concentration would have been less than the concentration required for effective stiffening of composites.

The combined effect of soybean hull fiber on strengthening, stiffening, and elongation/strain can be seen as changes in the toughness (area under the stress-strain curve), which is shown in FIG. 7E. AR-Dry composites showed a significant decrease in the toughness and with chemical treatment of soybean hulls the toughness of these composites improved (p<0.005; Student t-test). However, the toughness of the composites was always less than that of pure TPC. This trend was expected as the addition of any strengthening phase to the elastomers, such as TPC, can decrease their toughness due to enhanced stiffness and reduced elongation of the matrix. The reduction in the toughness could also have been due to the presence of porosity in these composites. The loss of mechanical properties, especially the strength and toughness, can be eliminated if porosity is reduced or eliminated by appropriate feedstock drying before composite preparation and increasing the concentration of soybean hull fibers.

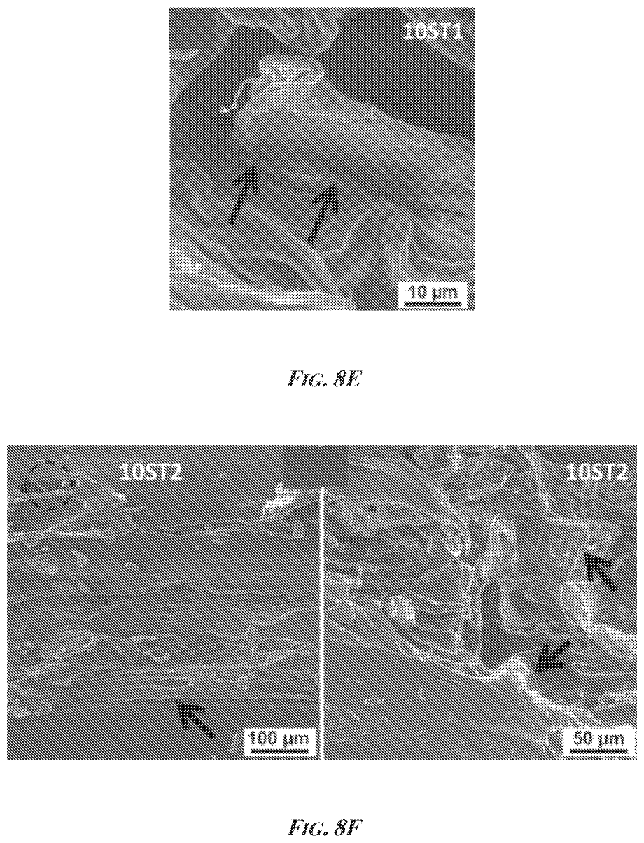

To understand the failure mechanism of pure TPC and TPC-soybean hull fiber composite filaments, the surfaces of the filaments were examined after tensile testing. Some selected filaments were stretched manually until failure, and the failed surface was analyzed using SEM. FIGS. 8A-8F show typical failure features observed on the stretched and failed surfaces of the filaments. Pure TPC filaments showed smooth surface without any dross defects or localized failure (see FIG. 8A). However, the composite filaments revealed localized surface tearing of the filaments, as shown in FIGS. 8B, 8C, and 8F. It was very interesting to note that these regions of failures always revealed soybean hull fibers, which were exposed to the surface before tensile testing (see FIGS. 4A-4D). Therefore, it can be said that surface exposed fibers or fiber bundles were detrimental to mechanical performance of NFRCs, as these regions were weak and could fail prematurely. Further, the high-magnification SEM analysis of the fracture surfaces, shown in FIG. 8D, revealed some shearing of the soybean hull fibers and presence of microfibrils (arrows). Fibers completely embedded in the TPC matrix can be seen in FIG. 8E. The intact interface between the soy hull fiber and TPC matrix clearly demonstrated good bonding between them in the present composites.

### Example 5

### Fiber-Matrix Interfacial Characteristics

Mechanical and other functional properties of NFCs depends on the fiber-matrix interfacial characteristics, which are dictated by hydrophilic and hydrophobic nature of fiber and matrix, respectively (Mohanty et al., 2000; Bogoeva-Gaceva et al., 2007). Wide variety of fiber modification methods, physical and chemical methods (Bogoeva-Gaceva et al., 2007), have been developed to improve fiber-matrix interfacial characteristics in NFCs. Majority of mechanical properties of NFCs depends not only on inherent properties of matrix and fiber, but also their adhesion. Other characteristics that have strong influence on the mechanical properties of these NFCs include concentration of fibers, fiber orientation, and fiber aspect ratio. For effective strengthening of present TPC-soybean hull fiber composite filaments during tensile testing the load must be transferred from the matrix to the fiber, which occur at fiber-matrix interface. As a result strong fiber-matrix adhesion is extremely important.

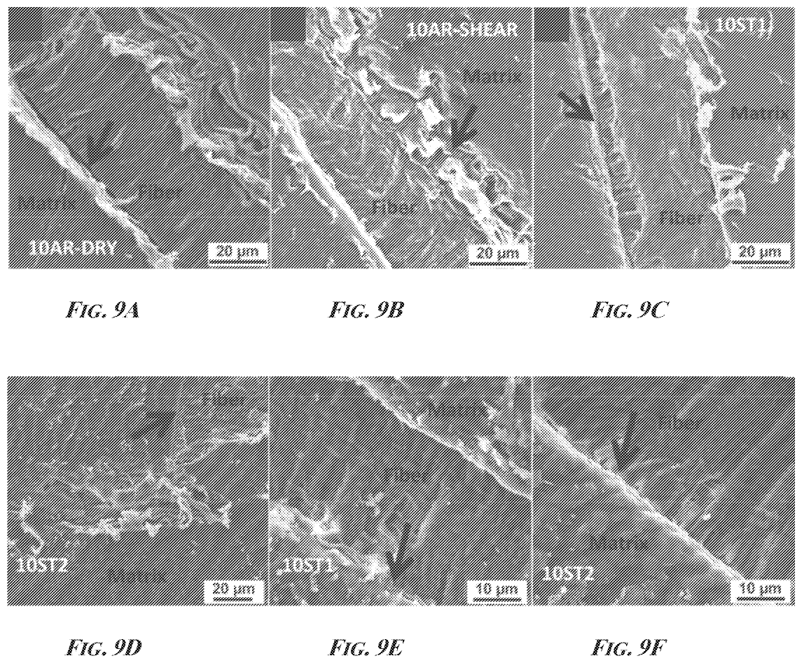

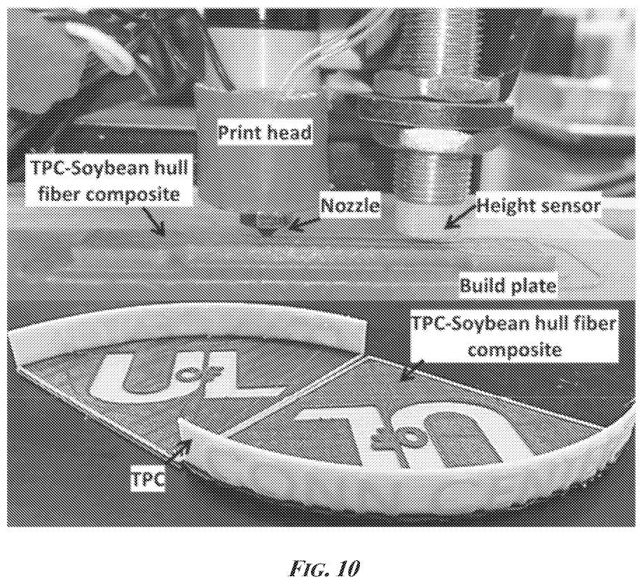

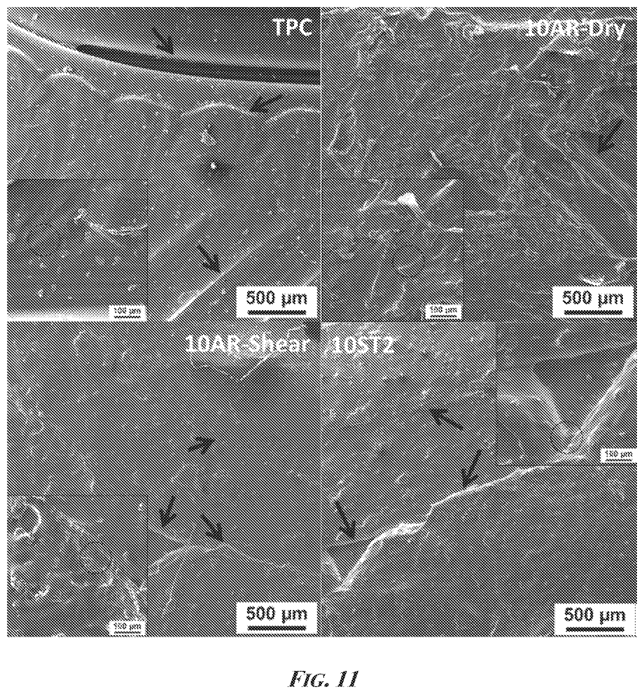

The fiber-matrix interfacial characteristics were thus examined using SEM and the microstructures of different composite filaments are shown in FIG. 9. As expected the interfacial bonding was poor in AR-Dry composites, as shown in FIG. 9A, which exhibited large gaps or debonded regions at the fiber-matrix interface. This resulted in low mechanical properties of these composites as the stress transfer between the matrix and the fiber was inefficient. Some decrease in the interfacial gap was observed with high-shear mixing of soybean hull fibers (FIG. 9B). This could have been due to the removal of impurities from the fiber surface and reduction in soybean hull fiber size, which enabled improved integration and surface area between the fiber and the matrix.

Further improvement in the fiber-matrix adhesion was exhibited by chemically treated soybean hull fibers. For example, the fiber-matrix interface was very compact and tight without any gap in ST1 and ST2 composites, as shown in FIGS. 9C and 9D, respectively. High-magnification SEM microstructures of these chemically treated soybean hull fibers composite samples is presented in FIGS. 9E and 9F. It can be seen that both samples showed the absence of any defects and gaps at the fiber-matrix interface. These observations clearly demonstrated that the present acid hydrolysis treatments were effective in improving fiber-matrix adhesion and dispersion of soybean hull fibers in TPC matrix. The improved interfacial characteristics of CTSHF composite filaments (ST1 and ST2) resulted in enhanced mechanical properties compared UTSHF composites (AR-Dry and AR-Shear). From the results presented herein, it can be concluded that the chemical treatment of soybean hull fibers reduced the amount of porosity and surface roughness of the filaments and enhanced the fiber distribution and fiber-matrix interfacial adhesion in TPC-soybean hull fiber composites. All of these were found to assist in enhancing the mechanical properties of the composites as compared to those of untreated soybean hull fibers.

Finally, a desktop printer was employed to make products using these filaments, and exemplary products are shown in FIG. 10.

### Discussion of Examples 1-5

Thermoplastic copolyester (TPC) composite filaments reinforced with soybean hull fibers were successfully prepared for use in FFF. The filaments were rough with uniform distribution of soybean hull fibers having ˜Ø 8 to 10 μm and 80 to 120 μm length. The extrusion viscosity decreased from 2700 Pa·s to a range between 1775 and 2100 Pa·s with addition of 5 wt. % soybean hull fibers. Acid hydrolysis of soybean hulls was found to restrict the increase in the viscosity with the increase in concentration, suggesting that some degree of shear thinning of TPC in the presence of soybean hull fibers.

CTSHF samples also exhibited a significantly low amount of porosity (2 to 5%) and pore size in these filaments. As a result, the tensile modulus of TPC increased from 44 MPa to 84 MPa (up to a 90% improvement) with a two-stage acid hydrolyzed soybean hull fibers. However, no significant improvement in the strength was achieved. Similarly, the enhanced stiffness and reduced elongation of TPC composite directly resulted in reduction in their toughness, which could have also been due to the presence of porosity. However, TPC-CTSHF composites exhibited 29% higher toughness than TPC-UTSHF composites.

The microstructural analysis of the filaments revealed that acid hydrolysis treatments were effective in improving fiber-matrix adhesion and soybean hull fiber dispersion in the TPC matrix. These improved interfacial characteristics in CTSHF filaments resulted in enhanced mechanical properties compared to UTSHF filaments. The abundant availability and low-cost of residual soybean hulls provide economic advantage and easy acceptance of these polymer composites for different applications.

### Introduction to Examples 6-8

Significant amount of research has been done on additive manufacturing (AM) or three-dimensional printing (3DP) of variety of polymers, thermoplastic and thermosetting, for various industrial applications (Bandyopadhyay et al., 2019). AM offers several advantages such as compositional and structural gradation, mathematically optimized complex designs, compared to conventional manufacturing of parts using these polymers (Bandyopadhyay et al., 2011). However, components made using AM are still found to be inferior to conventionally manufactured parts in terms of their mechanical and functional performance. As a result, processing of polymer composites reinforced with appropriate fillers that can provide improved performance is gaining attention. Considerable research and understanding on the polymer composites processing using different AM technologies have been reviewed (Parandoush & Lin, 2017; Wang et al., 2017). The majority of these composites are reinforced with synthetic fillers/fibers, which require large amount of energy to produce compared to natural fibers production (Joshi et al., 2004). Consequently there has been increasingly more demand for natural reinforcements in the production of polymer composites (Grand View Research, 2018), which provide low-cost feedstock, high strength-to weight ratio (depending on the fiber), biodegradability, recyclability and overall environmental sustainability. Wide variety of natural fibers including wood, kenaf, hemp, jute have been used in the fabrication of polymer composites using conventional processing routes (Jacob et al., 2006; Majid et al., 2010; Merlini et al., 2011; Cao et al., 2012; Jawaid et al., 2013).

Manufacturing high-strength natural fiber reinforced polymer composites (NFCs) using AM is relatively more challenging than conventional composites due to inherent characteristics of natural fibers (e.g., thermal stability, hydrophilicity), which make it difficult to eliminate inhomogeneities. Some of the important problems in AM processing of NFCs include nozzle clogging, gas porosity, agglomeration of fibers, material flow and viscosity variations (Le Duigou et al., 2016). Le Duigou et al. reported significant amount of porosity (˜16%) in the poly(lactic acid) (PLA)+poly(hydroxyalkanoate) (PHA)+15 wt. % wood fiber composite filaments, which could not be eliminated in the parts printed using FFF (Le Duigou et al., 2016). It was also found that the part size had strong influence on the porosity of these NFCs and the porosity increased with increasing the part size. In another study, PLA composites reinforced with wood particles (up to 50 wt. %) have been fabricated using FFF, and it was found that more than 10 wt. % wood can decrease the strength of the composites to MPa from 55 MPa (Kariz et al., 2018). Further, these printed parts were rough with large amount of porosity and wood particle agglomeration, and during printing nozzle clogging was also observed. There has been very little reported literature on AM of NFCs due to these difficulties.

Herein disclosed is FFF of thermoplastic copolyester (TPC) composites reinforced with 5 and 10 wt. % of dilute acid hydrolyzed and unhydrolyzed soybean hull fibers. Soybean hull fibers have been chosen as potential reinforcement because soybean production has been 123 million tons in 2018 and after processing (e.g., for oil, protein, etc.) the residual soy hulls have very low market value as soymeal and animal feed (Alemdar & Sam, 2008). Further, microfibrils and microparticles derived from soybean hulls were found have good thermal stability after being chemically processed (Ferrer et al., 2015; Ferrer et al., 2016), while their shear thinning behavior can be beneficial for composite processing. Therefore, soybean hull fibers were evaluated as reinforcing material in TPC composite fabrication. A goal was to analyze the microstructural and mechanical properties of TPC-soybean hull fiber composites made using FFF and to understand the influence of different physical and chemical treatments on these properties. Detailed topological and microstructural analysis was performed in terms of porosity, pore size, uniformity of fiber distribution and fiber-matrix interfacial characteristics, which were correlated with composites' mechanical properties.

### Materials and Methods for Examples 6-8

Preparation of TPC-soybean hull fiber composites. Soybean hulls (Owensboro Grain Company, Owensboro, Ky., United States of America) were used in different conditions with 5 and 10 wt. % to fabricate TPC composites using FFF to assess their potential as polymer reinforcing materials. Two sets of soybean hulls were prepared without chemical treatment (i.e., dry blending) and wet shear mixing (soy hulls:water=1:1.75 wt. %) to reduce their size. In another group, dilute acid hydrolysis (single-stage and double-stage) were employed to improve the wettability between soybean hull fibers and TPC matrix. More details about hydrolysis treatment can be found elsewhere (Fonseca et al., 2014; Tadimeti et al., 2020). These treatments were aimed to remove impurities and reduce hydrophilicity of soybean hulls, which is essential to achieve good compatibility with hydrophobic polymers. The details of different composites prepared in this investigation are presented in Table 2.

TABLE 2
Different Composites and FFF Parameters Employed

| Material | Treatment | Moisture % | FFF Printing Parameters | | |
|---|---|---|---|---|---|
| AR-Dry | Dry blended | 10.05 ± 0.37 | Layer | 200 | μm |
| | as-received hulls | | thickness | | |
| AR-Shear | Wet shear mixed | 3.61 ± 0.26 | Printing | 30 | mm/s |
| | as-received hulls | | speed | | |
| ST1 | Single-stage | 2.75 ± 0.52 | Extrusion | 500 | μm |
| | hydrolyzed hulls | | width | | |
| ST2 | Two-stage | 2.96 ± 0.31 | Printing | 220° | C. |
| | hydrolyzed hulls | | temperature | | |
| TPC | Neat TPC | | Bed | 65° | C. |
| | | | temperature | | |
| | | | Nozzle | 500 | μm |
| | | | diameter | | |

| | |
|---|---|
| Fill angle | ±45° |

Before mixing, the TPC granules were dried in an oven at 80° C. for 8 hours and the moisture content of the soybean hull fibers was determined using standard moisture analyzer. Different composite feedstocks were prepared by mixing appropriate amount of soybean hull fibers (to achieve 5 and 10 wt. % reinforcement) and TPC granules (DUPONT™ HYTREL®4056) using a torque rheometer (Intelli-Torque Plasti-Corder, C. W. Brabender Instruments, Inc. South Hackensack, N.J., United States of America) at 180° C., 50 RPM for 18 to 20 min. The composite mixtures were then crushed to small granules (1 to 5 mm), which were then extruded in the form of Ø 1.75 mm filaments using a capillary rheometer (Rheograph 20, GÖTTFERT Werkstoff-Prüfmaschinen GmbH, Buchen, Germany). The composite filaments were extruded at 165° C. with 0.15 mm/s speed (shear rate=30 s⁻¹) using a tungsten carbide die. The viscosity of different composites was also measured during filament extrusion. The extruded filaments were spooled and further used for FFF of composite parts.

Based on several experiments to print TPC-soybean hull fiber composites using a desktop FFF machine (Printrbot), the printing parameters shown in Table 2 were chosen to fabricate several test coupons for further characterization and testing. Initial printing experiments using extrusion temperatures between 200° C. and 240° C. showed that a temperature of 220° C. ensured consistent material flow during printing. Low extrusion temperatures resulted in severe nozzle clogging. Good part adhesion with build plate was achieved with a bed temperature of 65° C. All samples were printed with 100% infill density to achieve defect free, dense parts with high strength. Other important printing parameters are summarized in Table 2 and Simplify3D software was used to generate G-code for printing.

Physical characterization. The printed parts were characterized for their relative density to assess porosity and printing induced defects. Initially, the density (g/cm³) of soybean hull fiber and TPC granules was determined using a gas pycnometer. These density values were used to calculate the theoretical density (ρₜ, g/cm³) of the composites following the rule of mixtures. The density of 3D printed composite parts was experimentally measured using Archimedes principle (ρₑ, g/cm³). Then the relative density (%) of the 3D printed composites was calculated as: (ρ_{c}/ρₜ)×100. The surface roughness of the composite samples was measured with a portable surface roughness tester (Surftest SJ-210, Mitutoyo America Corporation, Mason, Ohio, United States of America) using a scan length of 5 mm at 0.5 mm/s speed. At least 12 scans were made on each sample (X-Y surface—top surface, X-Z surface—build direction) and an average roughness with standard deviation was reported. Further, the composites were examined using scanning electron microscope (SEM, TESCAN USA, Inc., Warrendale, Pa., United States of America) for surface topography, the presence of printing induced defects, porosity, and exposed soybean hull fibers.

Microstructural and mechanical properties. All composite samples, including pure TPC, were sectioned along and across build direction followed by cold mounting in acrylic resin. Then the mounted samples were ground on series of SiC emery papers and final polishing was performed on velvet cloth using 1 μm Al₂O₃ suspension. These polished sections of composite samples were analyzed for microstructural features such as fiber distribution, porosity, printing defects and fiber-matrix interface using SEM.

The tensile mechanical properties of printed composite test coupons, in terms of Young's modulus, stress at 5% and 50% strain (as none of the samples failed within the cross-head span of the tensile testing machine) and toughness (area under the stress-strain curve) were determined using universal testing machine at 100 mm/s cross head speed (ASTM D638). The tensile testing of the printed samples was carried out in normal to build direction. The mechanical properties were presented as the mean±standard deviation and Student's t-test was used to perform statistical analysis where p<0.05 was considered statistically significant. To understand the failure of TPC-soybean hull fiber composites made using FFF, selected tensile tested samples' surfaces were examined using SEM.

### Example 6

### Surface Topography, Roughness, and Density of 3D Printed Composites

Initially the surface morphology of as-printed TPC-soybean hull fiber composite parts was examined using SEM to understand the influence of soybean hull reinforcement on material's flow during printing and resultant changes in the morphology. FIG. 11 shows typical top surface morphology of pure TPC and its composite parts. As expected, the pure TPC parts showed relatively smooth surface morphology compared to the soybean hull fiber reinforced composites. All composite parts revealed miniature surface undulations and some exposed soybean hull fibers. Further, among these composites, the surface of the AR-Dry composites appears to be roughest, which can be attributable to the coarse fraction of untreated soybean hull fibers. With wet shear mixing and hydrolysis the reinforcements became finer, which resulted in smooth surface comparable to that of the pure TPC parts. Under present printing conditions some printing induced defects, primarily between the perimeter and infill interface, were observed as indicated by arrows in FIG. 11. However, the bonding between adjacent beads appears to be very good (circles in the insets in FIG. 11). At the same time, the bead-perimeter interfacial region and the interface between adjacent beads showed some material build up/overflow in pure TPC parts, which was relatively less in the composite parts. This is attributable to high viscosity of pure TPC (2700 Pa·s) compared to composites (1775 to 2100 Pa·s) at identical printing temperature of 220° C. The high viscosity of pure TPC also resulted in debonding or improper bonding between the beads at some locations (see FIG. 11). Although some geometrically difficult to fill areas (triangular areas in FIG. 11; 10AR-Shear and 10ST2 panels) were observed in the composite parts, the interface between the adjacent beads or layers appeared to be smooth suggesting complete bonding (see the insets of FIG. 11).

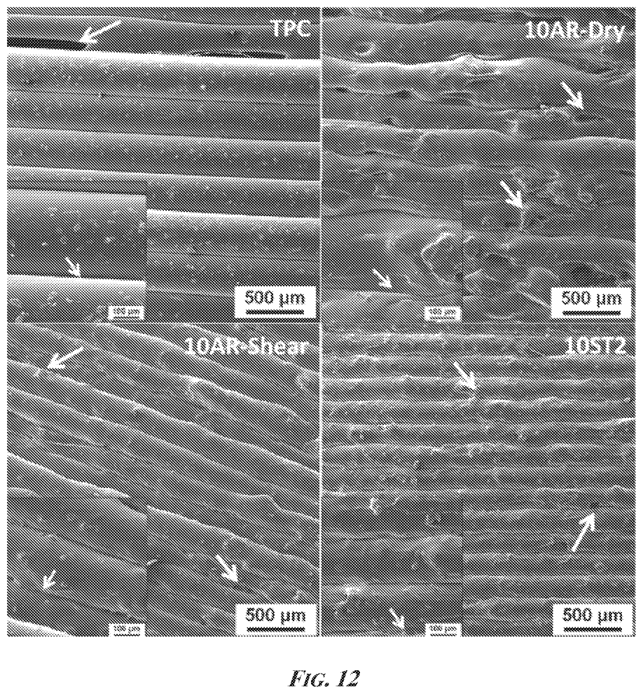

SEM microstructures showing typical surface morphology of FFF fabricated TPC and TPC-soybean hull composite parts along the build direction are presented in FIG. 12. All parts revealed good interlayer bonding with isolated defects. The interface between the layers was found to be straight in TPC parts due to its high viscosity compared to composites which exhibited uneven interface. The high viscosity of TPC also resulted in occasional debonding or unbonded regions between the layers, as shown in FIG. 12, which could be eliminated by increasing the printing temperature. All composites showed some exposed soybean hull fibers on the surface, which was unavoidable. However, the interface between the layers was found to be tight and diffuse in the composites, as shown in insets of FIG. 12, and therefore these parts are expected to have strong bonding. Relatively low viscosity of soybean hull fiber reinforced composites enabled better flow of material on previously printed layers and wetting with the same. As a result, the layer-to-layer and bead-to-dead bonding was found to be better in the composites than in the pure TPC parts, which exhibited a sharp interface between the layers (FIG. 12).

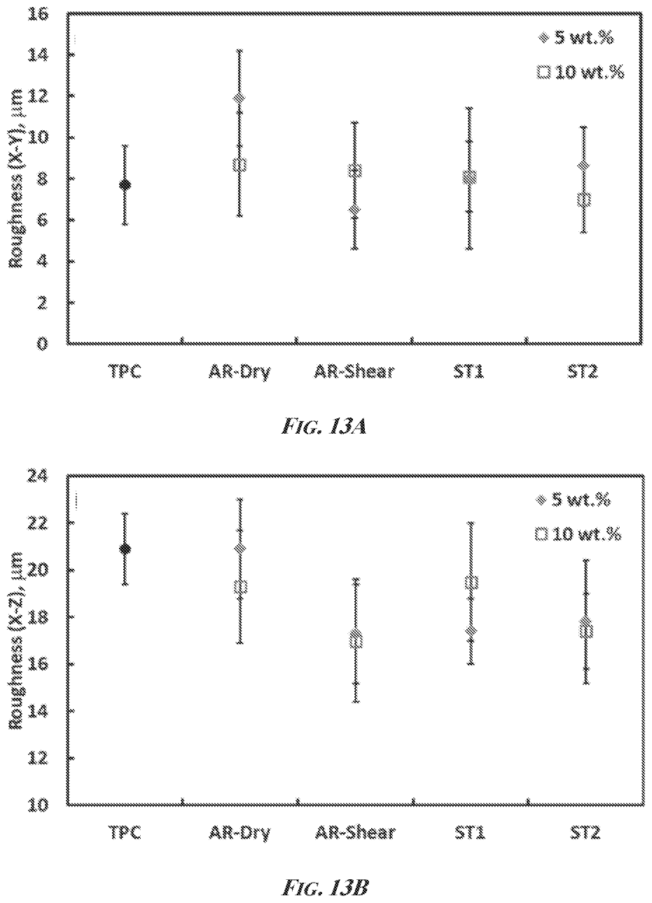

The influence of soybean hull fiber treatment and their concentration on the average roughness of 3D printed composite parts in different directions is shown in FIG. 13. The top surface roughness (Ra) of pure TPC parts was measured to be 7.7±1.9 μm and the composite parts exhibited roughness between 7.0±1.6 μm and 11.9±2.3 μm, depending on the treatment and concentration of soybean hull fiber. It can be seen from FIG. 13A that there was no significant difference in the average top surface roughness among the parts under present printing conditions. However, the observed variations could be directly ascribed to the reduction in melt viscosity and reinforcement size (80-120 μm for AR-Dry and AR-Shear, and 10-100 μm for ST1 and ST2) in the composites prepared using chemically treated fibers (ST1 and ST2), compared to untreated fibers (AR-Dry and AR-Shear). It was expected that increasing the concentration of soybean hull fiber in the composites would increase the surface roughness due to increased number of exposed fibers on the surface. However, it appeared that the easy material flow, due to the decrease in the viscosity during printing, would have worked against the anticipated increase in surface roughness with increased soybean hull fiber concentration. This could be beneficial during tensile testing as eliminating such potential weak regions (exposed hull fiber) can improve mechanical properties. The reduction in the exposed fibers was also expected to improve the moisture resistance of these NFCs. The roughness of the parts along the build direction, shown in FIG. 13B, was almost double that was observed on the top surface. For example, the roughness of pure TPC parts in build direction was 20.9±1.5 μm compared their top surface roughness of 7.7±1.9 μm. Similarly, the composite parts showed build direction roughness between 17.0±2.6 μm and 20.9±2.1 μm. As observed with top surface roughness, hydrolysis of soybean hull fibers helped in reducing the surface roughness marginally in the build direction under the tested printing conditions. Further improvements in the surface quality of these composites parts are achieved by fine tuning printing parameters and using high-end printers.

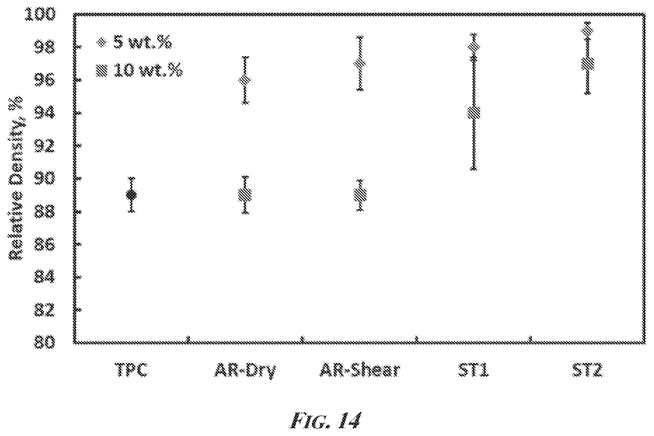

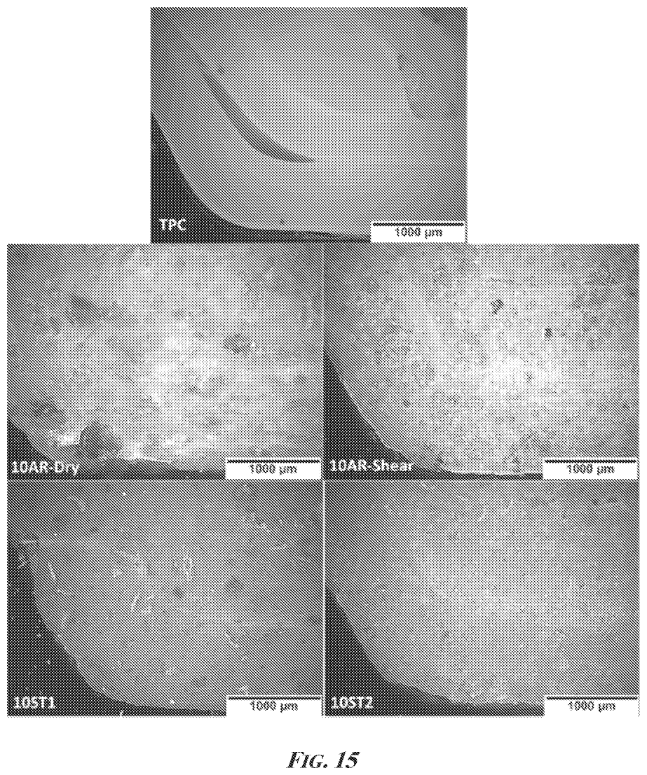

The relative density of 3D printed parts is presented in FIG. 14, which clearly showed beneficial effects of dilute acid hydrolysis of soybean hull fibers in achieving high density parts (low amount of total porosity). The composite parts showed a relative density between 89±0.9% and 99±0.5%, while the pure TPC part density was 89±1%. Relatively low density of pure TPC parts could be due to printing induced defects and lack of proper bonding between the beads as a result of its high viscosity under present printing conditions (Table 2), as shown in FIGS. 11 and 12. Among TPC-soybean hull fiber composites, the ST2 composites exhibited the highest relative density. Composites made using untreated fibers showed significant decrease in their density (97 to 89%) with increasing soybean hull fiber concentration from 5 to 10 wt. %. However, the chemical treatment of soybean hulls was found to reduce or eliminate the detrimental effect of increased soybean hull fiber concentration on the density of 3D printed composite parts. It can be seen from Table 2, that the moisture content of ST1 and ST2 samples was significantly less than the other two samples (p<0.01 to 0.0001), as the dilute acid hydrolysis could reduce the moisture content, lignin, and other impurities from these fibers (George et al., 2001; Pickering et al., 2016; Balla et al., 2019), which created porosity due to evaporation during composite processing. Therefore, the reduction in the porosity of the composites made with hydrolyzed soybean hull fibers was attributed to their low moisture content and hydrophilicity (Balla et al., 2019) leading to better bonding with the TPC matrix. Overall, the reduction in the porosity of these 3D printed composites could improve their mechanical properties.

### Example 7

### Microstructural Analysis

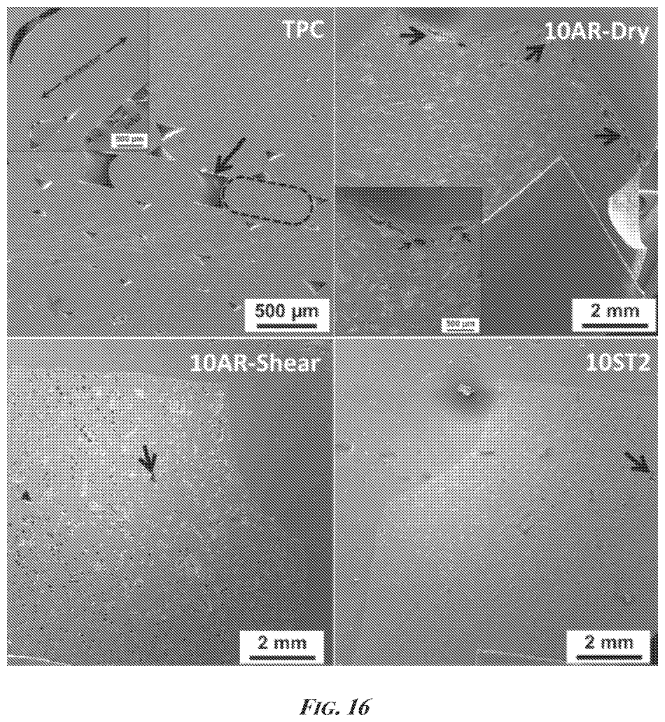

The microstructural analysis of 3D printed parts was performed on polished sections to understand printing induced defects, pore size, shape, and soybean hull fiber distribution. Initially, the regions of parts (tensile test coupons) that are geometrically difficult to print were examined and a comparison of low-magnification light microstructures of pure TPC and TPC-soybean hull fibers composite parts is shown in FIG. 15. It can be clearly seen that pure TPC parts had large printing-induced defects such as debonding or lack of bonding between beads as well as incomplete fill. However, such defects appeared to be absent in the composites due to their better flowability and wettability as a result of their low melt viscosity compared to pure TPC. The better flowability of the composites was reflected in their lower viscosity between 1775 and 2100 Pa·s compared to that of pure TPC with 2700 Pa·s. The bonding between the beads was also found to be sound across the composite part surface. However, the composites made using untreated soybean hull fibers (AR-Dry and AR-Shear) exhibited large fiber bundles along the parts' perimeters and some agglomerates as well. On the other hand, the fibers treated with dilute acid hydrolysis resulted in more uniform distribution of fibers within the deposited beads with excellent inter-bead bonding. SEM microstructures, shown in FIG. 16, provided clear differences in the defects observed in the 3D printed parts. The lack of bonding between the beads, in each layer, leading to the formation of characteristic inter-bead voids was seen in pure TPC parts. Similar voids were also observed between perimeters as well (inset of FIG. 16), which resulted in relatively low density in pure TPC parts (FIG. 14). Such voids were absent in the composite parts reinforced with treated soybean hull fibers, as shown in FIG. 16 (10ST2), while some small inter-bead voids were observed in 10AR-Shear parts. As discussed herein, better flowability and wettability of composite melt eliminated the formation of such gross voids. However, all composite parts revealed fine spherical or elliptical gas porosity due to water vapor liberation from the natural fibers during printing at 220° C. The amount of porosity was found to decrease with chemical treatment of fibers (10ST2) due to decrease in their moisture content compared to physically treated fibers.

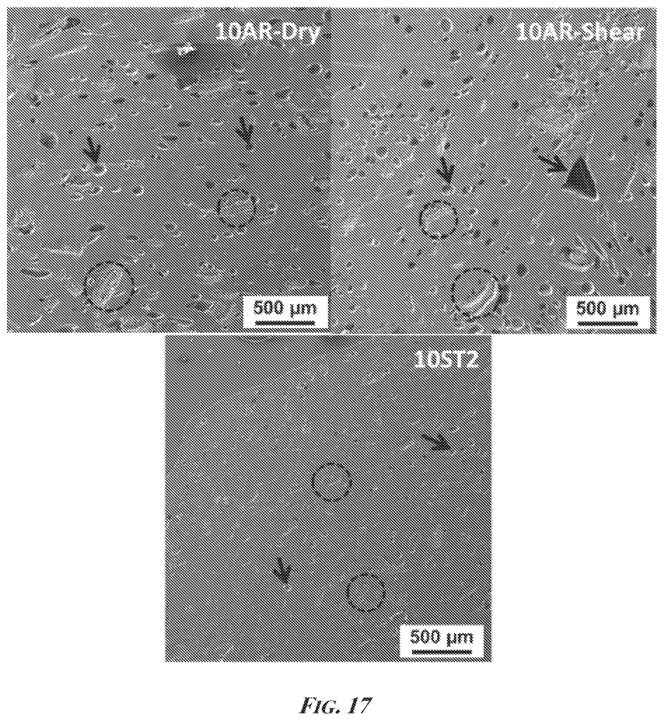

The composite parts were further examined for gas porosity characteristics using SEM at high magnification (see FIG. 17). Correlating with the results of relative density, shown in FIG. 14, dilute acid hydrolysis of soybean hull fiber significantly reduced the amount of porosity and pore size in these composites. Since the relative density of 10 wt. % composites is lower than that of composites with 5 wt. % soybean hull fibers, the pore size in these composites was quantitatively measured to understand the differences. The experimental data revealed 81±40 μm pores in 10AR-Dry composites, which was reduced to 58±21 μm after wet shear mixing of fibers and finally to 39±10 μm in the composites made using ST2 fibers. The pore size data and images of these composites, shown in FIG. 17, indicated large scatter in the pore size of AR-Dry and AR-Shear composites. This was due to large variations in their sizes and non-uniform distribution within the TPC matrix during printing. After dilute acid hydrolysis the soybean hull fibers became finer leading to uniform distribution in the matrix. Additional reduction in the moisture content (see Table 2) and hydrophilicity of chemically treated fibers (Balla et al., 2019) resulted in significant reduction in the porosity and pore size after 3D printing. Both hydrolysis treatments (ST1 and ST2) were found to provide comparable pore size at 10 wt. %. It is also important to note that no visible interface between successive beads could be seen in the present composite microstructures (see FIG. 17), which demonstrated complete and strong inter-bead bonding.

Although the printing induced voids and natural fiber induced gas porosity could influence mechanical properties of these composites, fiber-matrix interfacial characteristics played a decisive role, which depended on the hydrophilic and hydrophobic nature of fiber and matrix, respectively (Mohanty et al., 2000; Bogoeva-Gaceva et al., 2007). For improved fiber-matrix bonding, different physical and chemical surface modification approaches have been used (Bogoeva-Gaceva et al., 2007). As a result of improved fiber-matrix bonding, the load transfer between the fibers and the matrix can be effective and therefore better mechanical properties can be expected in such NFCs.

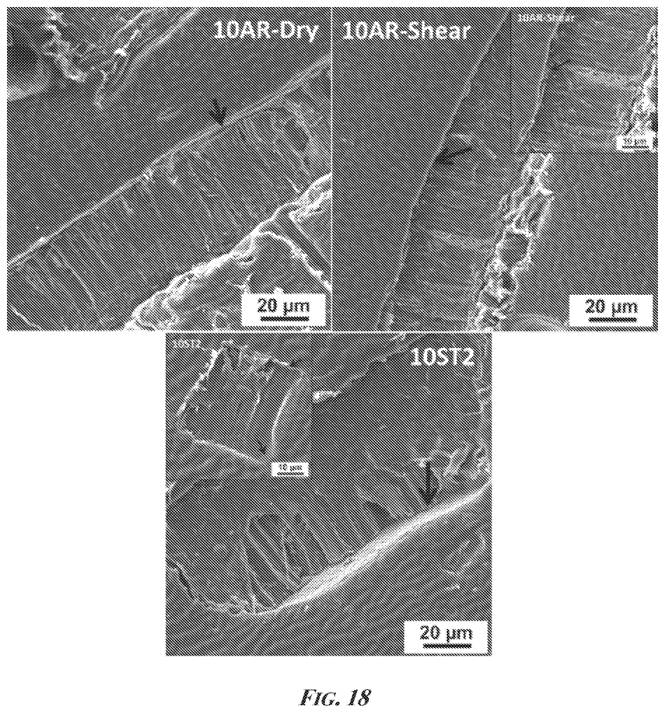

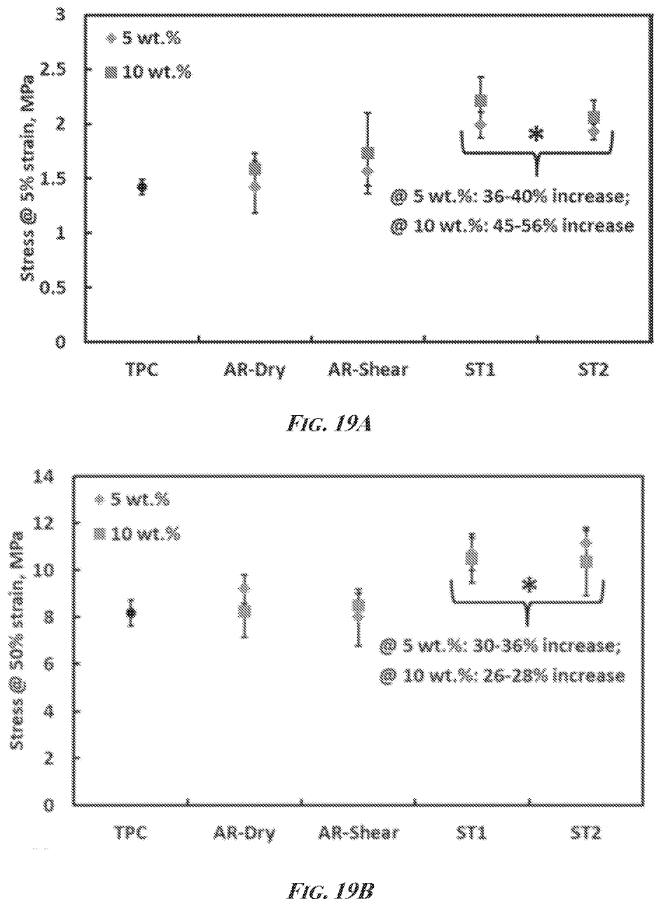

Therefore, the fiber-matrix interfacial characteristics in the present 3D printed soybean hull fiber composites were analyzed and the microstructures thus obtained are presented in FIG. 18. Composites made using AR-Dry fibers revealed a visible gap between the fiber and the TPC matrix. After wet shear mixing of as-received soybean hulls the interface appeared to be improved. It can be seen from inset of 10AR-Shear microstructure, shown in FIG. 18, the interfacial gap (indicated by arrow) was significantly reduced compared to that observed in 10AR-Dry composites. The fiber-matrix interface in 10ST2 composites was found to be compact with no visible gap. Complete and sound interfacial bonding could be clearly seen, indicated by arrows, from the inset of 10ST2 in FIG. 18. The observed improvement in the interfacial compatibility between hydrophobic TPC matrix and hydrophilic soybean hull fibers was due to the reduction in their surface hydrophilicity as a result of dilute acid hydrolysis, which removed lignin and other insoluble waxes and impurities from the surface of these fibers. The improved fiber-matrix interfacial characteristics in ST1 and ST2 composites were expected to have a positive influence on their mechanical properties compared to AR-Dry and AR-Shear composites.

### Example 8

### Mechanical Properties

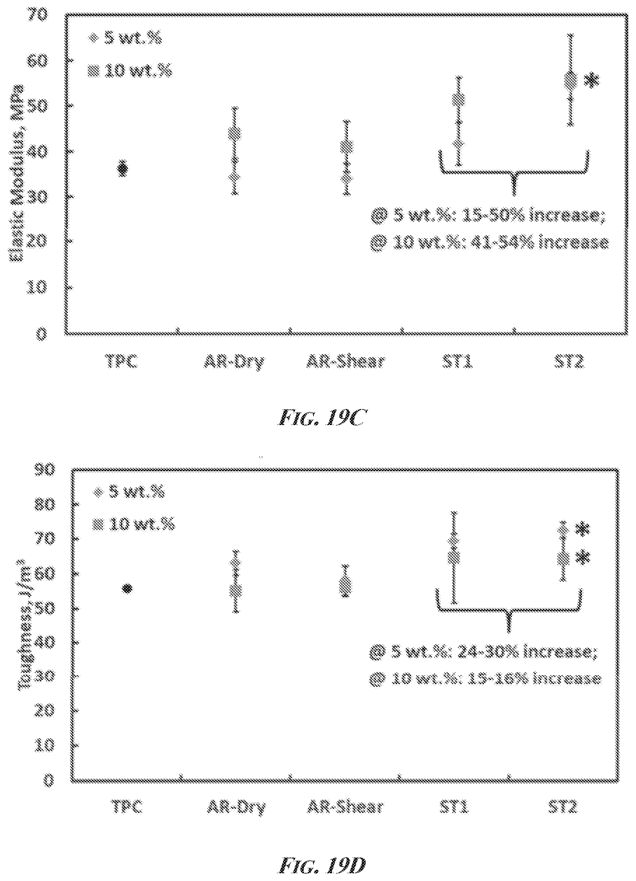

FIGS. 19A-19D show experimentally determined tensile mechanical properties of FFF fabricated pure TPC and TPC-soybean hull fiber reinforced composites, including stress at 5% strain (FIG. 19A), stress at 50% strain (FIG. 19B), elastic modulus (FIG. 19C), and toughness (FIG. 19D). It can be seen that the addition of hydrolyzed soybean hull fiber to TPC increased stress (at different strains), elastic modulus, and toughness, depending on the type of reinforcement and its concentration.

To understand the strengthening effect of different reinforcements the tensile stress at 5% and 50% strain of the samples was compared, as none of the samples fractured during tensile testing with tensile elongation between 750 and 800%. The data shown in FIG. 19A, indicated that the stress at 5% strain of pure TPC increased from 1.42±0.07 to 2.21±0.22 MPa with the addition of hydrolyzed soybean hull fibers (ST1 and ST2), which was an improvement of up to 56% depending on the concentration of fiber. With increase in the tensile strain to 50% (see FIG. 19B), the stress also increased to 11.13±0.55 MPa (8.18±0.55 for pure TPC). However, the improvement appeared to be low (up to 36%) compared to that achieved at low strain (5%). Interestingly, the strengthening effect was retained up to 50% strain by the composites with 5 wt. % hydrolyzed soybean hull fibers. Under present 3D printing conditions, pure TPC exhibited an elastic modulus of 36.3±1.6 MPa and that of composite parts varied between 34 and 56 MPa (see FIG. 19C). However, the statistical analysis using Student's t-test revealed an improvement between 41 to 54% in the elastic modulus of 5ST1, 5ST2, and 10ST2. The highest elastic modulus of between 54 and 56 MPa was recorded with ST2 composites. Similarly, the improvement in the toughness (area under the stress-strain curve; see FIG. 19D) of the ST2 composites with 5 wt. % and 10 wt. % reinforcement was found to be 30% and 15%, respectively. This drop in the toughness of 10ST2 composites could be attributable to the small decrease in the total elongation of these composites.

Overall, the present results showed that the dilute acid hydrolysis of soybean hull fibers could significantly improve mechanical properties of 3D printed TPC composites, compared to untreated fibers. Among the treatments, double-stage hydrolysis was found to be best to improve mechanical properties of these composites. As shown in FIG. 18, the composites printed using hydrolyzed fibers (ST1 and ST2) had compact/diffuse fiber-matrix interface (no sharp interface/gap), which enabled effective load transfer between the fiber and matrix leading to improvement in the mechanical properties.

Moreover, significant reduction in the amount of gas porosity in these composites (see FIG. 17) and pore size also assisted in achieving high mechanical performance in these composites. Hydrolysis treatment reduces the hydrophilicity and moisture contents of soybean hull fibers, which improved the microstructural characteristics and thereby the mechanical properties. Increasing the fiber concentration, from to 5 wt. % and 10 wt. %, was found to have a marginal influence on the mechanical properties.

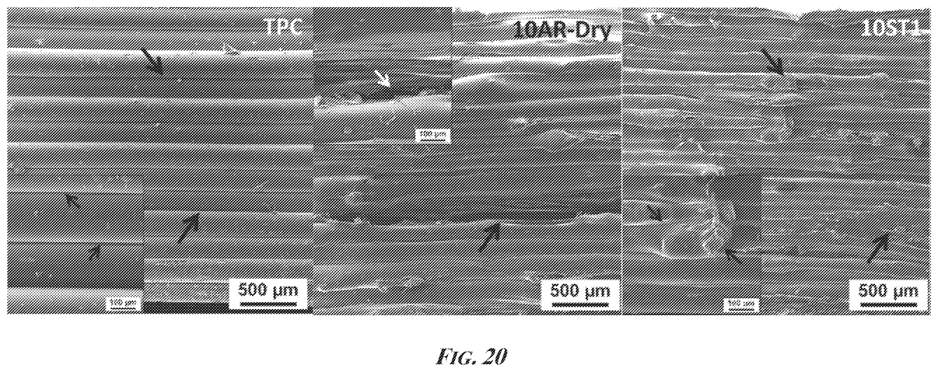

The surface of 3D printed composites was examined after tensile testing for any damage, especially delaminations, shear failures, etc., and typical surface morphologies are shown in FIG. 20. Pure TPC parts showed intact layers and no delamination was observed. However, AR-Dry composites revealed delamination of layers at several places, as shown in FIG. 20. The bonding between the perimeter and infill also failed in these composites. On the other hand, it can be seen from FIG. 20 that all layers were intact and delamination or shear between the layers was absent in the composites reinforced with hydrolyzed soybean hull fibers. The surface morphology was very similar to that found in as-printed condition (see FIG. 12). These features clearly demonstrated that the bonding between layers and between beads was very strong. Weak interfacial bonding could lead to debonding during tensile testing and as a result the stress experienced by each layer could be different. High-magnification SEM images, shown in the insets of FIG. 20, also did not reveal any delamination when treated fibers were used. However, due to high tensile stretching some of the exposed fibers on the surface of these composite samples were torn off the matrix. From these observations, it can be concluded that present 3D printed composites had strong bonding between layers and beads, especially ST1 and ST2 composites.

### Example 9

### Other Agricultural Fibers

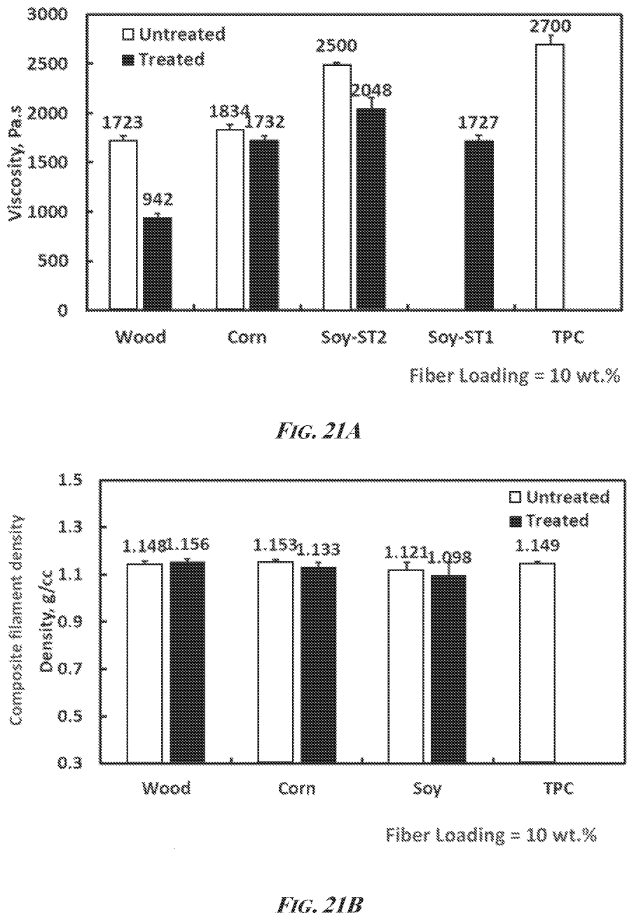

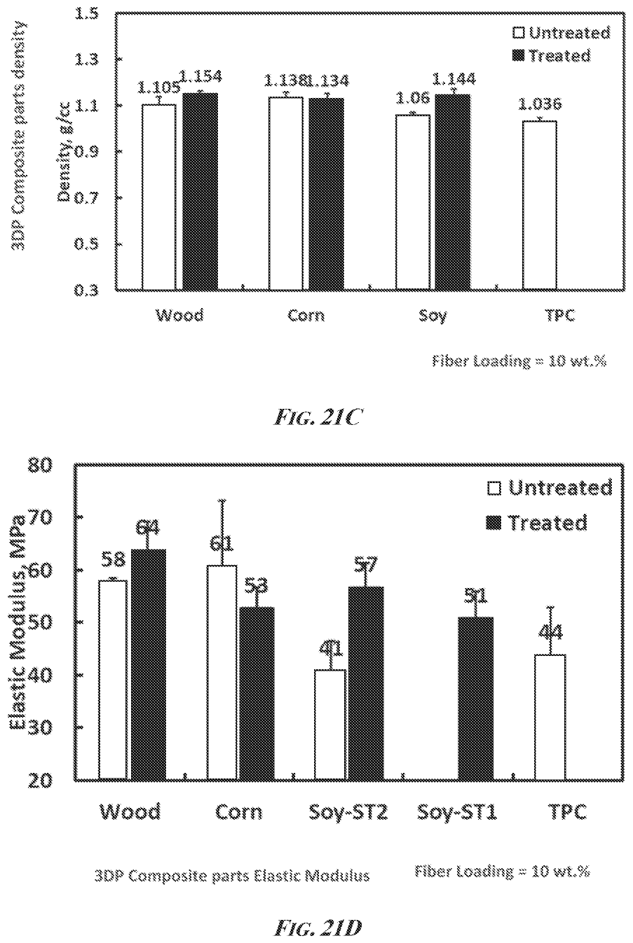

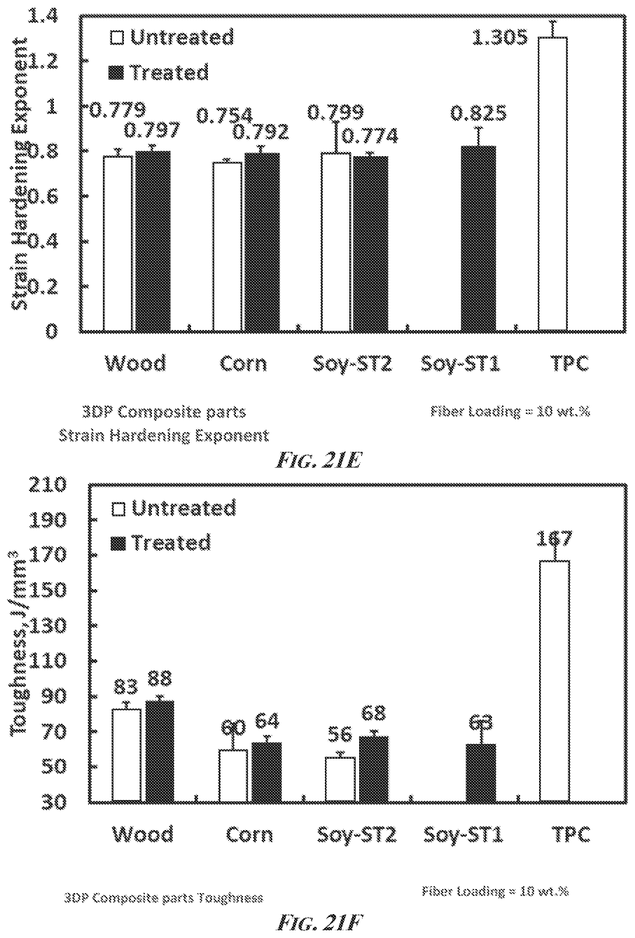

Comparisons of various characteristics among different agricultural fiber materials including wood, corn, and soy, treated with the methods of the presently disclosed subject matter were also performed. The results are presented in FIGS. 21A-21F.

At fiber loading of 10 wt. %, viscosity (FIG. 21A), composite filament density (FIG. 21B), 3DP composite parts density (FIG. 21C), elastic modulus (FIG. 21D), strain hardening exponent (FIG. 21E), and toughness (FIG. 21F) were tested.

### Discussion of Examples 6-9

As disclosed herein, soybean hull derived fibers have been evaluated as reinforcements to manufacture thermoplastic copolyester (TPC) composites using fused filament fabrication (FFF). The hulls subjected to physical and chemical treatments were used to understand their influence on the microstructural and mechanical properties of the composites. Strong dependence of surface quality, printing defects, and inter-bead/interlayer bonding on the type of fiber treatment was identified. Dilute acid hydrolysis treated fibers increased the relative density of composites to 99% and reduced the pore size from 81 μm to 39 μm. Defect-free fiber-matrix interfacial characteristics in these composites enhanced the elastic modulus from 36 MPa to 54 MPa. Similarly, the toughness and stress at 50% strain of these composites was ˜30% and 50% higher than that of pure TPC, respectively. The results presented herein clearly demonstrated that low-cost and abundantly available soybean hulls when modified using dilute acid hydrolysis have a strong potential in the fabrication of natural fiber reinforced composites.

Fused filament fabrication (FFF) was used to print thermoplastic copolyester (TPC) composite parts reinforced with soybean hull fibers, in different conditions, and their microstructural and mechanical properties were compared with pure TPC parts. The surface morphological features of printed parts found to depend on material flow during printing and gross defects were observed on pure TPC parts due to its higher viscosity compared to that of soybean hull fiber reinforced composites. The composite parts also exhibited relatively better interlayer and bead-to-bead bonding. Dilute acid hydrolysis of soybean hull fibers significantly reduced the surface roughness comparable to that of pure TPC parts. Moreover, the hydrolyzed fibers resulted in considerable reduction in gas porosity (from 11 to 1%) and their size (from 81 μm to 39 μm). High-magnification microstructural analysis of composites made with hydrolyzed fiber revealed compact and diffuse interfacial between the fiber and matrix, as a result of their reduced hydrophilicity. These microstructural features found to improve elastic modulus (up to 54%) and stress at 50% strain (up to 38%) of TPC when reinforced with 10 wt. % of two-stage hydrolyzed soybean hull fibers. Our results demonstrate that with appropriate chemical treatment of soybean hull fiber make them potential reinforcement to manufacture variety of natural fiber polymer composites using 3D printing.

### REFERENCES

All references cited in the instant disclosure, including but not limited to all patents, patent applications and publications thereof, scientific journal articles, and database entries, are incorporated herein by reference in their entireties to the extent that they supplement, explain, provide a background for, or teach methodology, techniques, and/or compositions employed herein.

With respect to the references cited in the disclosure and with the exception of their use in chemical formulae, numbers in brackets throughout the application correspond to the references listed herein below as follows:
Alemdar & Sam (2008) Isolation and characterization of nanofibers from agricultural residues Wheat straw and soy hulls, Bioresour. Technol. 99:1664-1671.
Balla et al. (2019) Additive manufacturing of natural fiber reinforced polymer composites: Processing and prospects. Compos Part B Eng 106956.
Bandyopadhyay et al. (2011) Micro-Layered Manufacturing. In Koc & Özel (eds) Micromanufacturing Design and Manufacturing of Micro-Products. John Wiley & Sons, Inc, pp 97-158
Bandyopadhyay et al. (2019) Additive Manufacturing of Polymers, in: Bandyopadhyay & Bose (eds.), Addit. Manuf, 2nd ed., CRC Press, pp. 25-42.
Bogoeva-Gaceva et al. (2007) Natural fiber eco-composites. Polym Compos 28:98-107.
Bouafif et al. (2009) Wood particle/high-density polyethylene composites: Thermal sensitivity and nucleating ability of wood particles. J Appl Polym Sci 113:593-600.
Bourell et al. (2017) Materials for additive manufacturing. CIRP Ann—Manuf Technol 66:659-681.
Bourmaud et al. (2018) Towards the design of high-performance plant fibre composites. Prog Mater Sci 97:347-408.
Cao et al. (2012) Maleated Natural Rubber as a Coupling Agent for Recycled High Density Polyethylene/Natural Rubber/Kenaf Powder Biocomposites, Polym.—Plast. Technol. Eng. 51:904-910.
Compton (2015) 3D printing of composites with controlled architecture, Engineering Conferences International, ECI Digital Archives, Composites at Lake Louise (CALL 2015) page 30.
Compton et al. (2014) 3D-Printing of Lightweight Cellular Composites. Advanced Materials 26:5930-5935
Faruk et al. (2012) Biocomposites reinforced with natural fibers: 2000-2010. Prog Polym Sci 37:1552-1596.
Ferrer et al. (2015) Dewatering of MNFC containing microfibrils and microparticles from soybean hulls: mechanical and transport properties of hybrid films, Cellulose. 22:3919-3928.
Ferrer et al. (2016) Physical, thermal, chemical and rheological characterization of cellulosic microfibrils and microparticles produced from soybean hulls, Ind. Crops Prod. 84:337-343.
Fonseca et al. (2014) Towards integrated biorefinery from dried distillers grains: Selective extraction of pentoses using dilute acid hydrolysis, Biomass and Bioenergy. 71:178-186.
George et al. (2001) A review on interface modification and characterization of natural fiber reinforced plastic composites. Polym Eng Sci 41:1471-1485.
Grand View Research (2018) Natural Fiber Composites (NFC) Market Size, Share & Trends Analysis Report By Raw Material, By Matrix, By Technology (Injection Molding, Compression Molding, Pultrusion), By Application, And Segment Forecasts, 2018-2024
Hristov et al. (2006) Surface tearing and wall slip phenomena in extrusion of highly filled HDPE/wood flour composites. Polym Eng Sci 46:1204-1214.
Jacob et al. (2006) Dynamical mechanical analysis of sisal/oil palm hybrid fiber-reinforced natural rubber composites, Polym. Compos. 27:671-680.
Jawaid et al. (2013) Effect of jute fibre loading on the mechanical and thermal properties of oil palm-epoxy composites, Compos. Part B Eng. 45:619-624.
Joshi et al. (2004) Are natural fiber composites environmentally superior to glass fiber reinforced composites? Compos. Part A Appl. Sci. Manuf 35:371-376.
Kalsoom et al. (2016) Recent developments in 3D printable composite materials. RSC Adv 6:60355-60371.
Kariz et al. (2018) Effect of wood content in FDM filament on properties of 3D printed parts, Mater. Today Commun. 14:135-140.
Kaseem et al. (2017) Effect of Wood Fibers on the Rheological and Mechanical Properties of Polystyrene/Wood Composites. J Wood Chem Technol 37:251-260.
Lau et al. (2018) Properties of natural fibre composites for structural engineering applications. Compos Part B Eng 136:222-233.
Le Duigou et al. (2016) 3D printing of wood fibre biocomposites: From mechanical to actuation functionality, Mater. Des. 96:106-114.
Maiti et al. (2004) Effect of wood fibers on the rheological properties of i-PP/wood fiber composites. J Appl Polym Sci 91:644-650.
Majid et al. (2010) Effects of Polyethylene-g-maleic Anhydride on Properties of Low Density Polyethylene/Thermoplastic Sago Starch Reinforced Kenaf Fibre Composites, Iran. Polym. J. 19:501-510.
Merlini et al. (2011) Influence of fiber surface treatment and length on physico-chemical properties of short random banana fiber-reinforced castor oil polyurethane composites, Polym. Test. 30:833-840.
Mohammed et al. (2015) A Review on Natural Fiber Reinforced Polymer Composite and Its Applications. Int J Polym Sci 2015:1-15.
Mohanty et al. (2000) Biofibres, biodegradable polymers and biocomposites: An overview. Macromol Mater Eng 276-277:1-24.
Parandoush & Lin (2017) A review on additive manufacturing of polymer-fiber composites, Compos. Struct. 182:36-53.
PCT International Patent Application Publication Nos. WO 2019/118476, WO 2019/118565.
Poletto et al. (2014) Native cellulose: Structure, characterization and thermal properties. Materials (Basel) 7:6105-6119.
Ramesh et al. (2017) Plant fibre based bio-composites: Sustainable and renewable green materials. Renew Sustain Energy Rev 79:558-584.
Tadimeti et al. (2020) A two-stage C5 selective hydrolysis on soybean hulls for xylose separation and value-added cellulose applications. Biomass Conversion and Biorefinery. doi/10.1007/s13399-020-00860-5.
Tanguy et al. (2018) Polypropylene reinforcement with flax or jute fibre; Influence of microstructure and constituents properties on the performance of composite. Compos Part B Eng 139:64-74.
Tian et al. (2018) Fabrication, properties and applications of soy-protein-based materials: A review. Int J Biol Macromol 120:475-490.
United States Department of Agriculture (2019) Soybean Production Up in 2018, USDA Reports Winter Wheat Seedings and Grain Stocks also reported. https://www.nass.usda.gov/Newsroom/2019/02-08-2019.php. Accessed 21 Jun. 2019.
U.S. Patent Application Publication Nos. 2015/0217514, 2016/0107379, 2018/0355196, 2017/0258623, 2020/0180219, 2020/0269503.
U.S. Pat. Nos. 5,121,329; 5,510,066; 7,569,273; 8,827,684; 10,173,410; 10,179,853; 10,232,443; 10,254,499; 10,912,351; 10,953,610.
Venkataraman (2000) The process-property-performance relationships of feedstock materials used for fused deposition of ceramics (FDC). Rutgers The State University of New Jersey—New Brunswick
Wang et al. (2017) 3D printing of polymer matrix composites: A review and prospective, Compos. Part B Eng. 110:442-458.
Zhong et al. (2001) Short fiber reinforced composites for fused deposition modeling. Mater Sci Eng A 301:125-130.

It will be understood that various details of the presently disclosed subject matter can be changed without departing from the scope of the presently disclosed subject matter. Furthermore, the foregoing description is for the purpose of illustration only, and not for the purpose of limitation.

1. A method for preparing a modified natural fiber composite feedstock, the method comprising:
(a) hydrolyzing an agricultural fiber, optionally a crop residue, further optionally a grain hull fiber from a plant selected from the group consisting of soybean, corn, and rice, under conditions and for a time sufficient to remove some or all of the arabinose from the agricultural fiber to produce an arabinose-deficient hydrolyzed product;
(b) thereafter hydrolyzing the arabinose-deficient hydrolyzed product under conditions and for a time sufficient to remove some or all of the xylose from the arabinose-deficient hydrolyzed product to produce a hydrolyzed fiber material, optionally a hydrolyzed soybean hull fiber material; and
(c) combining a thermoplastic copolyester (TPC) with up to 35 wt. % by weight of the hydrolyzed fiber material,
whereby a modified fiber composite feed stock is prepared.

2. The method of claim 1, wherein the first hydrolyzing step, the second hydrolyzing step, or both employ an acid.

3. The method of claim 2, wherein the first and second hydrolyzing steps are performed together or separately at the same temperature.

4. The method of claim 3, wherein the first hydrolyzing step employs a lower concentration of acid, a shorter treatment time, or both as compared to the concentration of acid and/or the treatment time employed in the second hydrolyzing step.

5. The method of claim 1, wherein the first hydrolyzing step removes at least about 40%, 50%, 60%, 70%, or greater than 70% of the arabinose present in the agricultural fiber, optionally wherein the agricultural fiber comprises soybean hulls, and/or removes less than 25%, 20%, 15%, or 10% of the xylose present in the agricultural fiber.

6. The method of claim 1, wherein the second hydrolyzing step removes at least about 40%, 50%, 60%, 70%, or greater than 70% of the arabinose remaining in the arabinose-deficient hydrolysis product, and/or removes greater than 70%, 75%, 80%, 85%, or 90% of the xylose remaining in the arabinose-deficient hydrolysis product.

7. The method of claim 1, wherein the thermoplastic copolyester (TPC) is combined with 5-35% by weight of the hydrolyzed fiber material, optionally wherein the hydrolyzed fiber material comprises hydrolyzed soybean hull fiber material.

8. The method of claim 1, wherein the combining of the thermoplastic copolyester (TPC) with the hydrolyzed fiber material, optionally the hydrolyzed soybean hull fiber material, results in a decrease in viscosity of the modified fiber composite as compared to the viscosity of the TPC absent the hydrolyzed fiber material.

9. The method of claim 1, wherein the combining of the thermoplastic copolyester (TPC) with the hydrolyzed fiber material, optionally the hydrolyzed soybean hull fiber material, results in an increase in the elastic modulus of the modified fiber composite of at least about 10%-50% as compared to the elastic modulus of the TPC absent the hydrolyzed fiber material, optionally the hydrolyzed soybean hull fiber material.

10. The method of claim 1, wherein the combining of the thermoplastic copolyester (TPC) with the hydrolyzed fiber material, optionally the hydrolyzed soybean hull fiber material, results in an increase in the toughness of the modified fiber composite of at least about 10%-30% as compared to the toughness of the TPC absent the hydrolyzed fiber material, optionally the hydrolyzed soybean hull fiber material.

11. The method of claim 1, wherein the modified fiber composite exhibits less than 10% moisture uptake when immersed in distilled water for up to 7 days.

12. The method of claim 1, further comprising isolating the xylose removed from the arabinose-deficient hydrolysate by:
(d) concentrating the xylose-containing solution produced in step (b) to greater than about 100 g/L;
(e) combining a boron compound with the concentrated xylose-containing solution to produce a xylose diester (XDE) boron derivative of the xylose;
(f) transesterifying the XDE boron derivative, optionally wherein the transesterifying is with propylene glycol, to form a precipitate, wherein the comprises xylose; and
(g) optionally filtering and/or washing the xylose to remove any solvents and impurities,
wherein the xylose is isolated from the arabinose-deficient hydrolysis product.

13. A modified fiber composite comprising up to 35 wt. % hydrolyzed agricultural fiber, optionally wherein the agricultural fiber comprises soy hulls, wherein the modified fiber composite is produced by a method of claim 1.

14. A method for 3D printing a structure, the method comprising preparing the modified fiber composite of claim 13 and employing the modified fiber composite in a fused filament fabrication (FFF) based additive manufacturing method to thereby print the structure.

15. A method for improving at least one characteristic of a modified thermoplastic copolyester (TPC) composite, the method comprising:
(a) hydrolyzing agricultural fiber material, optionally soybean hull fiber material, under conditions and for a time sufficient to remove some or all of the arabinose from the agricultural fiber material to produce an arabinose-deficient hydrolysis product;
(b) thereafter hydrolyzing the arabinose-deficient hydrolysis product under conditions and for a time sufficient to remove some or all of the xylose from the arabinose-deficient hydrolysis product to produce a hydrolyzed fiber material, optionally a hydrolyzed soybean hull fiber material; and
(c) combining a thermoplastic copolyester (TPC) with up to 35% by weight of the hydrolyzed fiber material, optionally the hydrolyzed soybean hull fiber material,
wherein the at least one characteristic is selected from the group consisting of reduced viscosity, reduced interfacial void spaces, enhanced fiber dispersion, and higher relative density of the TPC composite relative to the TPC lacking the hydrolyzed fiber material, optionally the hydrolyzed soybean hull fiber material.

16. A method for improving a fused filament fabrication (FFF) process, the method comprising employing the modified fiber composite of claim 13 rather than a thermoplastic copolyester (TPC) lacking the up to 35 wt. % hydrolyzed agricultural fiber materials, which can optionally comprise soy hulls, wherein the improving comprises a reduction in a parameter of the FFF process selected from the group consisting of viscosity, brittleness, nozzle clogging, void formation, fiber agglomeration, increased feature resolution, and/or an improved fiber-matric interfacial bonding characteristic.

17. A method for reducing occurrence of void spaces in a modified thermoplastic copolyester (TPC) composite, the method comprising:
(a) hydrolyzing agricultural fiber material, optionally soybean hull fiber material, under conditions and for a time sufficient to remove some or all of the arabinose from the agricultural fiber material to produce an arabinose-deficient hydrolysis product;
(b) thereafter hydrolyzing the arabinose-deficient hydrolysis product under conditions and for a time sufficient to remove some or all of the xylose from the arabinose-deficient hydrolysis product to produce a hydrolyzed fiber material, optionally a hydrolyzed soybean hull fiber material; and
(c) combining a thermoplastic copolyester (TPC) with up to 35% by weight of the hydrolyzed fiber material, optionally the hydrolyzed soybean hull fiber material, to produce a modified thermoplastic copolyester (TPC) composite,
wherein the modified thermoplastic copolyester (TPC) composite has a reduced occurrence of void spaces relative to the same thermoplastic copolyester (TPC) combined with up to 35% by weight of the same fiber material that has not been hydrolyzed.

18. The method of claim 17, wherein the modified thermoplastic copolyester (TPC) composite has an improvement of at least at least one additional characteristic selected from the group consisting of reduced viscosity, and higher relative density of the TPC composite relative to the TPC lacking the hydrolyzed fiber material.

19. The method of claim 17, wherein an extent to which the modified thermoplastic copolyester (TPC) composite has a reduced occurrence of void spaces is at least about 40%, 50%, 60%, 70%, or greater than 70% relative to the same thermoplastic copolyester (TPC) combined with up to 35% by weight of the same fiber material that has not been hydrolyzed.
